(19) United States
(12) Patent Application Publication
(10) Pub. No.: US 2011/0053792 A1
(43) Pub. Date: Mar. 3, 2011

(54) MICROARRAY FOR EXPRESSION ANALYSIS OF CELLULAR GLYCOSYLATION MECHANISM

(76) Inventor: Wolfgang Kemmner, Berlin (DE)

(21) Appl. No.: 12/682,172

(22) PCT Filed: Oct. 8, 2008
(86) PCT No.: PCT/EP08/08498

§ 371 Date: Sep. 28, 2010

(30) Foreign Application Priority Data
Oct. 8, 2007 (EP) 07019664.7

(51) Int. Cl. C40B 30/04; C40B 40/06

(52) U.S. Cl. 506/9; 506/16

(57) ABSTRACT

The present invention relates to a support onto which a set of probes is applied wherein the set comprises: (a) probes capable of specifically hybridising with nucleic acids encoding fucosyltransferases; (b) probes capable of specifically hybridising with nucleic acids encoding galactosyltransferases; (c) probes capable of specifically hybridising with nucleic acids encoding N-acetylglucosaminyltransferases; (d) probes capable of specifically hybridising with nucleic acids encoding N-acetylgalactosaminyltransferases; (e) probes capable of specifically hybridising with nucleic acids encoding sialyltransferases; (f) probes capable of specifically hybridising with nucleic acids encoding sugar sulfotransferases; (g) probes capable of specifically hybridising with nucleic acids encoding lectins; (h) probes capable of specifically hybridising with nucleic acids encoding selectins; (i) probes capable of specifically hybridising with nucleic acids encoding fucosidases; (j) probes capable of specifically hybridising with nucleic acids encoding neuraminidases (sialidases); (k) probes capable of specifically hybridising with nucleic acids encoding nucleotide sugar epimerases; (l) probes capable of specifically hybridising with nucleic acids encoding sugar kinases; (m) probes capable of specifically hybridising with nucleic acids encoding sugar epimerases; (n) probes capable of specifically hybridising with nucleic acids encoding sugar transporters; and (o) probes capable of specifically hybridising with nucleic acids encoding enzymes of the fucose or sialic acid metabolism. The invention further relates to a kit which comprises the probes of the invention and the use of the support or the kit of the invention for the quantitative determination of expression profiles in a sample obtained from a cell, a tissue or an organism. The present invention further relates to a diagnostic composition and the use of the set of probes of the invention for the preparation of diagnostic compositions or of a diagnostic apparatus for the diagnosis of tumours, inflammatory and/or neurological diseases.

The present invention relates to a support onto which a set of probes is deposited wherein the set comprises: (a) probes capable of specifically hybridising with nucleic acids encoding fucosyltransferases; (b) probes capable of specifically hybridising with nucleic acids encoding galactosyltransferases; (c) probes capable of specifically hybridising with nucleic acids encoding N-acetylglucosaminyltransferases; (d) probes capable of specifically hybridising with nucleic acids encoding N-acetylgalactosaminyltransferases; (e) probes capable of specifically hybridising with nucleic acids encoding sialyltransferases; (f) probes capable of specifically hybridising with nucleic acids encoding sugar sulfotransferases; (g) probes capable of specifically hybridising with nucleic acids encoding lectins; (h) probes capable of specifically hybridising with nucleic acids encoding selectins; (i) probes capable of specifically hybridising with nucleic acids encoding fucosidases; (j) probes capable of specifically hybridising with nucleic acids encoding neuraminidases (sialidases); (k) probes capable of specifically hybridising with nucleic acids encoding nucleotide sugar epimerases; (l) probes capable of specifically hybridising with nucleic acids encoding sugar kinases; (m) probes capable of specifically hybridising with nucleic acids encoding sugar epimerases; (n) probes capable of specifically hybridising with nucleic acids encoding sugar transporters; and (o) probes capable of specifically hybridising with nucleic acids encoding enzymes of the fucose or sialic acid metabolism. The invention further relates to a kit which comprises the probes of the invention and the use of the support or the kit of the invention for the quantitative determination of expression profiles in a sample obtained from a cell, a tissue or an organism. The present invention further relates to a diagnostic composition and the use of the set of probes of the invention for the preparation of diagnostic compositions or of a diagnostic apparatus for the diagnosis of tumours, inflammatory and/or neurological diseases.

A number of documents including patent applications and manufacturers' instructions of the prior art are mentioned in the description. While the disclosure content of these documents is not considered relevant for the patentability of the invention, it is incorporated by reference into the present description.

An essential post-translational modification is glycosylation by which sugars are enzymatically attached to proteins. Glycosylation serves different functions, such as the stabilisaton of proteins by protection against proteolytic degradation. Also the correct protein conformation and the affinity to binding partners associated therewith may depend on glycosylation. The glycosylation of proteins further affects their intracellular transport, contributes to cell interaction or serves as a structural component of cell membranes. The most important sugars that play a role in glycoproteins are fucose, galactose, mannose, glucose, xylose, N-acetylgalactosamine, N-acetylglucosamine and N-acetylneuraminic acid. The binding to proteins can be N-glycosidic or O-glycosidic. N-glycosylation occurs at the endoplasmatic reticulum by the binding of a sugar to the free amino group of asparagine. O-glycosylation, however, occurs at the Golgi apparatus by binding of the sugar to the hydroxyl group of serine, threonine, hydroxyproline or hydroxylysine.

The structure of the specific glycosylation pattern of a cell depends on the expression as well as on the activity of the molecules of the glycosylation machinery, such as e.g. glycosyltransferases, degrading enzymes (e.g. sialidases), sugar transporters and glycoprotein-binding molecules. The large number of glycosyltransferases described is presumably caused by the high three-fold specificity of glycosyltransferases. These are specific for i) the substrate, i.e. the sugar that is transferred, ii) the acceptor to which the sugar is transferred and iii) the type of bond that is established between the two partners.

Sialyltransferases, which catalyse the transfer of a nucleotide-activated sialic acid to specific sugar side-chains, play an important role for glycoprotein-producing cells, since the terminal sialic acid is very important for the biological activity and/or half-life of glycoproteins. The expression of sialyltransferases also plays an important role in the diagnostic of tumour diseases.

Also enzymes and transporters which play an important role in sugar metabolism, can be of significant importance for the diagnosis of different diseases. Furthermore, these enzymes and transporters are of interest for the recombinant production of glycoproteins.

Another important group of molecules are lectins, such as galectins, selectins and sialic acid-binding lectins. These lectins are the receptors for the sugar side-chains on the cell membrane. Many of these lectins are involved in immunological recognition mechanisms and, for example, the induction of apoptosis/anoikis.

Specific changes of the glycan structure on the cell surface are characteristic of a number of diseases and, thus, may be used for their diagnosis. One example is the early diagnosis of carcinomas having an increased metastasic potential. Liver cells, for example, carry receptors on their surface which bind specific glycoproteins and, in this way, regulate the half-life of serum proteins. The Thomsen Friedenreich TF glycan, which is present on the surface of tumour cells, is bound by the receptors and facilitates the metastasis of tumour cells into the liver. There is an interrelationship with sialyltransferase ST6GalNAc-II, the over-expression of which correlates with an increased presence of TF and is of prognostic relevance (Schneider et al., 2001). It has been known for some time that certain acidic sugars (sialic acids) increasingly occur in glycan structures of metastasizing tumour cells. This is consistent with the fact that also the activity of the enzyme catalyzing said structures (sialyltransferase ST6Gal-I) is increased in metastasizing colorectal carcinomas (Kemmner at al., 1994). Similar results were found in studies on gastric carcinomas, renal carcinomas and mamma carcinomas.

Other glycan structures are responsible for the binding of tumour cells circulating in the blood to specific receptors on endothelia of blood vessels, i.e. selectins. Also this process is very important in the metastasis of colorectal carcinoma and can be used to evaluate the prognosis for a patient. The selectins themselves are glycoproteins which normally initiate the glycan-depending interactions of leucocytes with the endothelium. These result in the migration of leucocytes into centres of inflammation. Thus, glycan structures are also important with respect to the organisation of the immune defence and have diagnostic potential also in this respect.

U.S. Pat. No. 6,566,060 analyses the expression of glycosyltransferases with the aim of determining the tumorigenic potential of brain cells and the treatment of neurological diseases.

US patent application no. US 2004/0204381 describes reagents and methods for the treatment and prevention of diseases that are caused by changes in the sialylation and glycosylation patterns of proteins.

US patent application 2003/0175734 describes materials and methods for the determination of the predisposition of cells to develop malignant phenotypes, in particular brain tumours. These methods are based on the analysis of expression patterns of oncogenes and tumour suppressor genes.

WO02059350 discloses the use of sialyltransferases, in particular sialyltransferase ST6GalNAc-II for the diagnosis and therapy of tumour diseases.

However, no approach is known in the prior art which allows the comprehensive analysis of the glycosylation apparatus.

Thus, the problem underlying the present invention was the provision of improved and/or modified means and methods for the analysis of the glycosylation apparatus. This problem is solved by the provision of the embodiments defined in the claims.

Consequently, the present invention relates to a support onto which a set of probes is deposited wherein the set comprises: (a) probes capable of specifically hybridising with nucleic acids encoding fucosyltransferases; (b) probes capable of specifically hybridising with nucleic acids encoding galactosyltransferases; (c) probes capable of specifically hybridising with nucleic acids encoding N-acetylglucosaminyltransferases; (d) probes capable of specifically hybridising with nucleic acids encoding N-acetylgalactosaminyltransferases; (e) probes capable of specifically hybridising with nucleic acids encoding sialyltransferases; (f) probes capable of specifically hybridising with nucleic acids encoding sugar sulfotransferases; (g) probes capable of specifically hybridising with nucleic acids encoding lectins; (h) probes capable of specifically hybridising with nucleic acids encoding selectins; (i) probes capable of specifically hybridising with nucleic acids encoding fucosidases; (j) probes capable of specifically hybridising with nucleic acids encoding neuraminidases (sialidases); (k) probes capable of specifically hybridising with nucleic acids encoding nucleotide sugar epimerases; (l) probes capable of specifically hybridising with nucleic acids encoding sugar kinases; (m) probes capable of specifically hybridising with nucleic acids encoding sugar epimerases; (n) probes capable of specifically hybridising with nucleic acids encoding sugar transporters; and (o) probes capable of specifically hybridising with nucleic acids encoding enzymes of the fucose or sialic acid metabolism.

The term “support” refers to a device having a surface onto which the probes of the invention can be deposited. This surface in accordance with the, invention may be a surface of any kind. The surface may be a coating which was applied onto the support or it may be the surface of the support itself. Suitable materials for the support are known to the person skilled in the art and include synthetic materials, glass, silica, gold, stainless steel, Teflon, nylon and silicon. Coatings in accordance with the invention, as far as they are used, include poly-L-lysin and aminosilan coatings as well as epoxide- and aldehyde-activated surfaces.

In a preferred embodiment, the support is miniaturised, for example in form of a chip, a disk, a bead or a microtitre plate. The support in accordance with the invention permits the parallel analysis of a plurality of individual detections in a small amount of sample material.

In a further preferred embodiment, each probe is assigned a defined coordinate in order to permit the evaluation of the results e.g. by using robot-assisted automated test procedures. The use of supports further avoids mixing or a “spill-over” of samples and, in addition, allows long-term preservation.

The term “probe” refers to a nucleic acid molecule which is preferably used in molecular biological hybridisation methods for sequence-specific detection of DNA and RNA molecules. The preparation of the probes can be carried out using any method known in the art, for example, the probes may be synthesised enzymatically and chemically. The probes can, for example, be synthesised directly onto the support by “in situ” synthesis using photolithography or ink-jet systems (Gao et al., 2001; Lausted et al., 2004) or can be deposited in a contact-free manner using piezoelectric or steel needles which deposit smallest amounts upon contact with the surface. The application of the probes can be carried out e.g. using spotting robots (Auburn et al., 2005).

In this context, nucleic acid molecule refers to all naturally occurring nucleic acid molecules, such as DNA or RNA, as well as to artificial base analogues, such as PNA (Peptide Nucleotide Acids; Harris and Winssinger, 2005) or LNA (Locked Nucleic Acids; Castoldi et al., 2006).

Fucosyltransferases (EC 2.4.1.-) belong to the group of glycosyltransferases, in particular to the group of hexosyltransferases, and catalyse the transfer of fucose from an activated sugar phosphate, e.g. GDP-fucose, to a protein or a sugar.

Galactosyltransferases (EC 2.4.1.-) belong to the group of glycosyltransferases, in particular to the group of hexosyltransferases, and catalyse the transfer of galactose from an activated sugar phosphate, UDP-galactose, to a protein or a sugar.

N-acetyl-glucosaminyltransferases (EC 2.4.1.-) belong to the group of glucosyltransferases, in particular to the group of hexosyltransferases, and catalyse the transfer of N-acetylglucosamin from an activated sugar phosphate, e.g. UDP-GlcNAc, to a protein or a sugar.

N-acetyl-galactosaminyltransferases (EC 2.4.1.-) belong to the group of glycosyltransferases, in particular to the group of hexosyltransferases, and catalyse the transfer of N-acetyl-galactosamine from an activated sugar phosphate, e.g. UDP-GalNAc, to a protein or a sugar.

Sialyltransferases (E 2.4.99.-) belong to the group of glycosyltransferases and catalyse the transfer of nucleotide-activated sialic acid, e.g. CMP-NeuAc, to a protein or a sugar.

Sugar sulfotransferases (EC 2.8.2) belong to the group of sulfotransferases and catalyse the transfer of a sulphate group of the nucleotide analogue 3′-phosphoadenosine-5′-phosphosulfate (PAPS) to a sugar.

Lectins are glycoproteins which are capable of specifically binding to sugar residues of cells and/or cell membranes and of inducing biochemical reactions from there. Lectins do not have enzymatic activity.

Selectins are a group of carbohydrate-binding adhesion molecules which are in particular involved in cell-cell-interactions of the immune system. In the context of an inflammation, selectins mediate for example the “rolling” of leucocytes on activated endothelial cells and contribute to the slowing of leucocyte velocity and their exit from the blood stream (Sperandio, 2006).

Fucosidases (EC 3.2.1.-) belong to the group of glycosidases and catalyse the hydrolytic cleavage of fucose from sugar residues.

Neuraminidases (EC 3.2.1.-) belong to the group of glycosidases and catalyse the hydrolytic cleavage of terminal sialic acid residues from glycoproteins on the cell surface. Neurominidases are also known to the person skilled in the art as sialidases.

Nucleotide sugar epimerases (EC 5.1.3.-) belong to the group of isomerases and catalyse the sterochemical transformation of a nucleotide sugar into its isomeric structure (i.e. molecules having the same empirical molecular formula, but different structural formulas).

Sugar kinases (EC 2.7.-.-) belong to the group of transferases, in particular phosphotransferases. Sugar kinases catalyse the phosphorylation of hydroxyl groups of sugar molecules.

Sugar epimerases (EC 5.1.3.-) belong to the group of isomerases and catalyse the stereochemical transformation of a sugar molecule into its isomeric structure (i.e. molecules having the same empirical molecular formula, but different structural formulas).

Sugar transporters are proteins which bind specific sugars and nucleotide-activated sugars, such as e.g. GDP-fucose, and serve to transport sugar. This includes the transport of sugar within the cell, e.g. from the cytoplasm to the Golgi apparatus or the endoplasmatic reticulum, as well as sugar transport from the extracellular space into the cell.

Enzymes of the fucose or sialic acid metabolism are part of the metabolic chain that catalyse the synthesis of sialic acid or fucose from glucose. Furthermore, the group of enzymes of the fucose or sialic acid metabolism also includes enzymes that catalyse the transformation of fucose and sialic acid taken-up by the cell to the nucleotide-activated sugars CMP-sialic acid and GDP-fucose. Enzymes of the fucose or sialic acid metabolism are, for example, N-acetylneuraminate synthase (NANS; EC 2.5.1.56), CMP-N-acetylneuraminic acid hydroxylase (CMAH; EC 1.14.18.2), N-acetylneuraminate pyruvate-lyase (NPL; EC 4.1.3.3), N-acetylglucosamine kinase (NAGK; EC 2.7.1.59), glucosamine (UDP-N-acetyl)-2-epimerase/N-acetylmannosamine kinase (GNE; EC 5.1.3.14), fucose-1-phosphate guanylyltransferase (FPGT; EC 2.7.11.1), cytidine monophosphate N-acetylneuraminic acid synthetase CMAS; EC 2.7.7.43), phosphoglucomutase 3 (PGM3; EC 5.4.2.3), UDP-galactose 4-epimerase (GALE; EC 5.1.3.2), transplantation antigen P35B (Fx/TSTA3; EC 1.1.1.271), fucokinase (FUK; EC 2.7.1.52), sialate-O-acetylesterase (SIAE/OAE; EC 3.1.1.53) and renin binding protein (RENBP; EC 5.1.3.8).

For the above-listed enzymes, reference was made to the classification according to the Enzyme Commission (EC) number system commonly used in the state of the art. In this system, each enzyme is assigned a code of four numbers. The first number refers to the enzyme class. In total, the enzymes are classified into 6 enzyme classes: oxidoreductases, transferases, hydrolases, lyases, isomerases and ligases. The other numbers provide an even more detailed characterisation of the enzymes, such as information about the substrates, the group transferred and the type of the bond formed or cleaved. This characterisation is hierarchical and depends on the individual enzyme class.

“Comprise” in accordance with the invention means that, apart from the probes mentioned additional probes, for example control probes, may be deposited onto the support. Control probes may be, for example, probes encoding genes of Aradopsis thaliana (thale cress) and to which human RNA does not bind. Thus, it is possible to control the efficiency of fluorescent labelling at the cDNA level and the equal quality of arrays by translating and hybridising exactly titered amounts of corresponding RNA of Arabidopsis thaliana with each analysis. Further examples of additional probes are inter alia “guidance spots” for correct positioning of the support and qualitative analysis of the results. Furthermore, probes may be used which bind nucleic acids the expression of which should not change in different tissues and cell lines (housekeeping gene) and which, thus, serve as internal controls.

Supports which contain only probes that specifically hybridise with nucleic acids encoding fucosyltransferases, galactotransferases, acetyl-glucosaminyl transferases, acetyl-galactosaminyl transferases, sialyltransferases, sugar sulfotransferases, lectins, selectins, fucosidases, neuraminidases (sialidases), nucleotide sugar epimerases, sugar kinases, sugar epimerases, sugar transporters and enzymes of the fucose or sialic acid metabolism, as defined above, are also taken into consideration.

The term “hybridise” in accordance with the invention refers to the binding of the probes of the invention to a complementary strand of polynucleotides whereby these form a hybrid. Methods for carrying out hybridisation experiments are known in the art and the person skilled in the art knows the conditions which have to be applied for hybridisation according to the invention. Such hybridisation techniques can be found in text books such as Sambrook, Russell “Molecular Cloning, A Laboratory Manual” Cold Spring Harbor Laboratory, N.Y. (2001); Ausubel, “Current Protocols in Molecular Biology”, Green Publishing Associates and Wiley Interscience, N.Y. (1989), or Higgins and Hames (Eds.) “Nucleic acid hybridization, a practical approach”, IRL Press Oxford, Washington D.C., (1985).

Stringent hybridisation conditions include conditions comprising e.g.: overnight incubation at 65° C. in 4×SSC (600 mM sodium chloride, 60 mM sodium citrate), followed by a washing step at 65° C. in 0.1×SSC for 1 hour. Alternatively, it is possible to incubate at 42° C. in a solution that contains 50% formamide, 5×SSC (750 mM sodium chloride, 75 mM sodium citrate), 50 mM sodium phosphate (pH 7.6), 5× Denhardt's solution, 10% dextrane sulphate and 20 μg/ml denatured, sheared DNA from salmon sperm, followed by washing steps in 0.1×SSC of 5 to 20 minutes at approximately 65° C. These hybridisation conditions are known to the person skilled in the art as highly stringent hybridisation conditions.

Less stringent conditions are also contemplated in accordance with the invention. Less stringent conditions for hybridisation and signal detection can be achieved, for example, by varying temperature or salt concentration. Low stringent hybridisation conditions are achieved e.g. by incubation at 50° C. in 4×SSC. Furthermore, changing the concentration of formamide can achieve less stringent conditions (lower formamide concentrations result in less stringent hybridisation), including, for example: an overnight incubation at 37° C. in a solution containing 30% formamide, 6×SSPE (20×SSPE=3 M NaCl, 0.2 M NaH₂PO₄, 0.02 M EDTA, pH 7.4), 0.5% SDS, 100 μg/ml DNA from salmon sperm and subsequent washing at 50° C. with 1×SSPE and 0.1% SDS. These conditions can be further varied by using alternative blocking reagents for the suppression of background signals. Such alternative blocking reagents are, for example, Denhardt's solution, BLOTTO, heparin, denatured DNA from salmon sperm as well as other commercially available reagents. If alternative blocking reagents are used, the hybridisation conditions may have to be adjusted to the respective experimental conditions.

Preferred probes of the invention are probes which, under stringent conditions, bind to a species of the above-mentioned nucleic acids without cross-reacting with other nucleic acids.

The term “probes capable of specifically hybridising with nucleic acids” refers to probes which, under suitable conditions, specifically hybridise with the relevant nucleic acids. Said suitable conditions preferably are stringent hybridisation conditions as defined above. In a preferred embodiment, a probe hybridises only with one nucleic acid, e.g. encoding for a specific fucosyltransferase or a specific galactosyltransferase. Alternatively, it is preferred that a probe hybridises with several nucleic acids of the same type of enzymes (e.g. fucolsyltransferases) for example when this type of enzyme is characterised by a common motif. In this regard, the term “type of enzyme” refers to a group of enzymes. Thus, for example, the fucosyltransferases defined in (a) represent one type of enzymes, likewise the galactosyltransferases defined in (b) etc. Of course, there are always several probe molecules of a species deposited on the support. The term “probes” also includes that only one specific probe sequence per enzyme or type of enzyme is deposited onto the support. In an alternative embodiment, several different probe sequences hybridising with different molecules of a type of enzymes (e.g. fucolsyltransferases) and/or with one enzyme of a type of enzymes, are deposited onto the support.

The support of the invention offers the advantage of a complete analysis of the molecules of the glycosylation machinery in one assay as well as the advantage that carrying out the analysis requires little time and small amounts of test material in comparison to other techniques. Thus, this comprehensive assay provides a sensitive, quick and parallel analysis of the components of the glycosylation apparatus based on micro-arrays. The arrays allow to detect the expression of all the glycosyltransferases and the other molecules of the glycosylation machinery within a short time and starting from a small number of cells. This is for example an advantage with respect to the diagnosis of tumour diseases or inflammatory and/or neurological diseases, in particular.

In accordance with the invention, the term “tumour” refers to the new formation of body tissues (neoplasias) which are formed due to a dysregulation of cell growth. A distinction is made between benign and malignant tumours.

Inflammatory diseases in accordance with the invention are diseases which represent a first reaction of the immune system to infections or stimuli, such as e.g. physical stimuli, microorganisms, allergens, toxins or dysfunctional enzymes, having the function to eliminate or remedy the damaging stimulus. Frequently occuring inflammatory diseases are, for example, arthritis, myocarditis, dermatitis, otitis, pneumonia, rheumatic diseases, Crohn's disease, ulcerative colitis, spondylitis, osteoarthritis or psoriasis.

Neurological diseases in accordance with the invention are diseases of the nervous system. The organ systems concerned are the central nervous system and the peripheral nervous system including the surrounding structures. Neurological diseases comprise, for example, multiple sclerosis, cerebral meningitis, inflammation of the spinal cord, cerebral infarction, Parkinson's disease, brain tumours, migraine, epileptic diseases, dementias and muscular dystrophies.

The determination of the expression of the glycosyltransferases in their entirety and other molecules of the glycosylation apparatus can also be advantageous for the analysis of glycosylation in production cell lines. Since glycans play a crucial role in the formation of correctly folded functional proteins, this expression analysis provides an innovative technology for the preparation of glycosylated biopharmaceuticals with optimised activity. The importance of this knowledge concerning the glycosylation patterns with respect to pharmacological bioactivity and bioavailability of proteins is particularly striking when, due to a lack of glycosylation or faulty glycosylation, the therapeutic use and success of recombinant proteins fall short of expectations.

A further advantage is the possibility of a simple and quick qualitative and quantitative determination of changes of the different molecules of the glycosylation apparatus that are expressed in a cell line subsequent to specific glyco-engineering. Cell lines often have to be subjected to additional glyco-engineering either to enhance specific glycosyltransferase activities and/or to exclude others. It is possible that other elements of the glycosylation machinery also react to such specific interventions. Thus, the comprehensive approach of the support of the invention offers the possibility to detect also surprising, unforeseen expression changes. Another advantage consists in the small amount of sample required since a single cell already provides sufficient test material. Thus, in comparison with standard methods such as sugar analysis by HPLC, the support of the invention provides a cost and labour saving method. Further advantages of the invention will be mentioned in connection with the preferred embodiments.

The invention further relates to a support onto which a set of probes is deposited, wherein the set comprises: (a) probes capable of specifically hybridising with nucleic acids encoding fucosyltransferases; (b) probes capable of specifically hybridising with nucleic acids encoding galactosyltransferases; (c) probes capable of specifically hybridising with nucleic acids encoding N-acetylglucosaminyltransferases; (d) probes capable of specifically hybridising with nucleic acids encoding N-acetylgalactosaminyltransferases; (e) probes capable of specifically hybridising with nucleic acids encoding sialyltransferases; (f) probes capable of specifically hybridising with nucleic acids encoding sugar sulfotransferases; (g) probes capable of specifically hybridising with nucleic acids encoding lectins; (h) probes capable of specifically hybridising with nucleic acids encoding selectins; (i) probes capable of specifically hybridising with nucleic acids encoding fucosidases; (j) probes capable of specifically hybridising with nucleic acids encoding neuraminidases (sialidases); (k) probes capable of specifically hybridising with nucleic acids encoding nucleotide sugar epimerases; (l) probes capable of specifically hybridising with nucleic acids encoding sugar kinases; (m) probes capable of specifically hybridising with nucleic acids encoding sugar epimerases; (n) probes capable of specifically hybridising with nucleic acids encoding sugar transporters; and/to (o) probes capable of specifically hybridising with nucleic acids encoding enzymes of the fucose or sialic acid metabolism, wherein at least one probe selected from (k), (l) or (m) is contained in the set of probes.

The characterising features of this embodiment are as defined above.

According to the invention, the term “wherein at least one probe selected from (k), (l) or (m) is contained in the set of probes” refers to a set of probes containing at least probes that are capable of specifically hybridising with nucleic acids encoding nucleotide sugar epimerases; and/or probes that are capable of specifically hybridising with nucleic acids encoding sugar kinasases and/or probes that are capable of specifically hybridising with nucleic acids encoding sugar epimerases. In a preferred embodiment, the set contains probes capable of specifically hybridising with nucleic acids encoding nucleotide sugar epimerases and probes capable of specifically hybridising with nucleic acids encoding sugar kinases as well as probes capable of specifically hybridising with nucleic acids encoding sugar epimerases. According to the invention, the set of probes may comprise further probes as mentioned under (a) to (j) and (n) to (o) in any possible combination.

As shown in the Examples 2 and 4 below based on the example of the key enzyme of sialic acid synthesis (UDP-N-acetylgucosamine-2-epimerase/N-acetylmannosamine kinase (GNE)), the analysis of the mRNA expression profile of sugar kinases and sugar epimerases can be used to derive direct information about the glycosylation pattern, in this case the density of sialic acid, on the cell surface.

In a preferred embodiment the support is a solid support.

A solid support in accordance with the invention is a support characterised by high stability and the possibility of miniaturisation.

In a further preferred embodiment, the support is made of glass.

In another preferred embodiment, the probes are oligonucleotide probes. Oligonucleotide probes in accordance with the invention have a length of at least 30 nucleotides. Oligonucleotide probes can be produced in a molecular biological way or synthetically (such as, for example, the oligonucleotide probes used by Affymetrix, U.S. Pat. Nos. 5,445,934 and 5,744,305). In another preferred embodiment, a protein in accordance with the invention can be represented by several different oligonucleotides.

In another preferred embodiment, probes are deposited onto the support that have a length of 40 to 100 bases. In a more preferred embodiment, the probes have a length of 50 to 90 bases, even more preferably a length of 60 to 80 bases and most preferably a length of approximately 70 bases. All values within these ranges, e.g. probes having a length of 62, 65, 68, 72, 75 or 78 bases are explicitly comprised by the preferred embodiments.

In another preferred embodiment of the support of the invention, fucosyltransferases, galactotransferases, acetyl-glucosaminyl transferases, acetyl-galactosaminyl transferases, sialyltransferases, sugar sulfotransferases, lectins, selectins, fucosidases, neuraminidases (sialidases), nucleotide sugar epimerases, sugar kinases, sugar epimerases, sugar transporters and/or enzymes of the fucose or sialic acid metabolism are selected from Table 1.

TABLE 1
Gene list of fucosyltransferases, galactosyltransferases, acetyl-glucosaminyl transferases,
acetyl-galactosaminyltransferases, sialyltransferases, sugar-sulfotransferasen, lectins, selectins,
fucosidases, neuraminidases (sialidases), nucleotide sugar epimerases, sugar kinases, sugar
epimerases, sugar transporters and/or enyzmes of the fucose or sialic acid metabolism.

| | | | SEQ ID | SEQ ID | SEQ ID |
|---|---|---|---|---|---|
| GlycoGene | Database No. | Gene name | NO: | Oligo 1 | Oligo 2 |
| SEPT9 | NM_006640 | Homo sapiens Septin 9 | 128 | 368 | |
| | GI:19923366 | | | | |
| A4GALT | NM_017436 | Homo sapiens alpha-1,4- | 1 | 207 | |
| | GI:55956926 | galactosyltransferase | | | |
| | | (globotriaosylceramide synthase) | | | |
| A4GNT | NM_016161.1 | Homo sapiens alpha-1,4-N- | 2 | 208 | |
| | GI:7705858 | acetylglucosaminyltransferase | | | |
| ACT | NM_001101 | beta-Actin | 179 | 209 | 417 |
| AFG3L2 | NM_006796 | Homo sapiens AFG3 (ATPase family | 3 | 210 | |
| | GI:5802969 | gene 3-like 2; yeast); nuclear gene, | | | |
| | | coding for mitochondrial protein | | | |
| ANXA4 | NM_001153 | Homo sapiens annexin A4 | 4 | 211 | 418 |
| | GI:4809272 | | | | |
| ARAF | NM_001654 | Homo sapiens v-raf murine sarcoma | 5 | 212 | 419 |
| | GI:4502192 | 3611 viral oncogene, homologous | | | |
| B2M | NM_004048 | Homo sapiens beta-2-microglobulin | 6 | 213 | |
| | GI:37704380 | | | | |
| B3GALNT1 | NM_003781 | Homo sapiens UDP-Gal:betaGlcNAc | 188 | 214 | |
| | GI:84452144 | beta-1,3-galactosyltransferase, | | | |
| | | polypeptide 3 (globoside blood group) | | | |
| | | (B3GALT3), transcript variant 1 | | | |
| B3GALNT2 | NM_152490 | Homo sapiens UDP-GalNAc:betaGlcNAc | 7 | 215 | |
| | GI:22749020 | beta-1,3-galactosaminyltransferase, | | | |
| | | polypeptide 2 | | | |
| B3GALT1 | NM_020981 | UDP-Gal:betaGlcNAc beta-1,3- | 8 | 216 | |
| | GI:15451870 | galactosyltransferase, polypeptide 1 | | | |
| B3GALT2 | NM_003783 | Homo sapiens UDP-Gal:betaGlcNAc | 9 | 217 | |
| | GI:15451871 | beta-1,3-galactosyltransferase, | | | |
| | | polypeptide 2 | | | |
| B3GALT4 | NM_003782 | Homo sapiens UDP-Gal:betaGlcNAc | 10 | 218 | |
| | GI:51702476 | beta-1,3-galactosyltransferase, | | | |
| | | polypeptide 4 | | | |
| B3GALT5 | NM_006057 and | Homo sapiens UDP-Gal:betaGlcNAc | 180; 466 | 219 | |
| | NM_033173 | beta-1,3-galactosyltransferase, | | | |
| | | polypeptide 5 | | | |
| B3GALT6 | NM_080605 | Homo sapiens UDP-Gal:betaGal | 11 | 220 | |
| | GI:37537720 | beta-1,3-galactosyltransferase, | | | |
| | | polypeptide 6 | | | |
| B3GNT1 | NM_006876.2 | Homo sapiens UDP-GlcNAc:betaGal | 12 | 221 | |
| | GI:92091577 | beta-1,3-N- | | | |
| | | acetylglucosaminyltransferase 1 | | | |
| B3GNT2 | NM_006577 | Homo sapiens UDP-GlcNAc:betaGal | 13 | 222 | 420 |
| | GI:92091578 | Beta-1,3-N- | | | |
| | | acetylglucosaminyltransferase | | | |
| B3GNT3 | NM_014256 | Homo sapiens UDP-GlcNAc:betaGal | 14 | 223 | |
| | GI:92091603 | beta-1,3-N- | | | |
| | | acetylglucosaminyltransferase 3 | | | |
| B3GNT4 | NM_030765 | Homo sapiens UDP-GlcNAc:betaGal | 15 | 224 | |
| | GI:42544235 | beta-1,3-N- | | | |
| | | acetylglucosaminyltransferase 4 | | | |
| B3GNT5 | NM_032047 | Homo sapiens UDP-GlcNAc:betaGal | 16 | 225 | 421 |
| | GI:44680131 | beta-1,3-N- | | | |
| | | acetylglucosaminyltransferase 5 | | | |
| B3GNT6 | NM_138706 | Homo sapiens UDP-GlcNAc:betaGal | 17 | 226 | |
| | GI:47271458 | beta-1,3-N- | | | |
| | | acetylglucosaminyltransferase 6 | | | |
| B3GNT7 | NM_145236 | Homo sapiens UDP-GlcNAc:betaGal | 18 | 227 | |
| | GI:21687138 | beta-1,3-N- | | | |
| | | acetylglucosaminyltransferase 7 | | | |
| B3GNT8 | NM_198540 | Homo sapiens UDP-GlcNac:betaGal | 19 | 228 | |
| | GI:42821106 | beta-1,3-N- | | | |
| | | acetylglucosaminyltransferase 8 | | | |
| B3GNTL1 | NM_001009905 | Homo sapiens UDP-GlcNAc:betaGal | 20 | 229 | |
| | GI:57770467 | beta-1,3-N- | | | |
| | | acetylglucosaminyltransferase-like 1 | | | |
| B4GALNT1 | NM_001478 | Homo sapiens beta-1,4-N- | 21 | 230 | 422 |
| | GI:84781815 | acetylgalactosaminyltransferase 1 | | | |
| B4GALNT2 | NM_153446.1\| | Homo sapiens beta-1,4-N- | 22 | 231 | |
| | [23592223] | acetylgalactosaminyltransferase 2 | | | |
| B4GALNT3 | NM_173593.3 | Homo sapiens beta-1,4-N- | 23 | 232 | 423 |
| | | acetylgalactosaminyltransferase 3 | | | |
| B4GALNT4 | NM_178537.3 | Homo sapiens beta-1,4-N- | 24 | 233 | |
| | | acetylgalactosaminyltransferase 4 | | | |
| B4GALT1 | NM_001497 | Homo sapiens UDP-Gal:betaGlcNAc | 25 | 234 | 424 |
| | GI:13929461 | beta-1,4-galactosyltransferase, | | | |
| | | polypeptide 1 | | | |
| B4GALT2 | NM_003780.3 | Homo sapiens UDP-Gal:betaGlcNAc | 26 | 235 | |
| | GI:53759111 | beta-1,4-galactosyltransferase, | | | |
| | | polypeptide 2 | | | |
| B4GALT3 | NM_003779 | Homo sapiens UDP-Gal:betaGlcNAc | 27 | 236 | |
| | GI:13929468 | beta-1,4-galactosyltransferase | | | |
| | | polypeptide 3 | | | |
| B4GALT4 | NM_003778 | Homo sapiens UDP-Gal:betaGlcNAc | 28 | 237 | |
| | GI:47078256 | beta-1,4-galactosyltransferase, | | | |
| | | polypeptide 4, transcript variant 2 | | | |
| B4GALT5 | NM_004776.2 | Homo sapiens UDP-Gal:betaGlcNAc | 29 | 238 | |
| | GI:13929470 | beta-1,4-galactosyltransferase, | | | |
| | | polypeptide 5 | | | |
| B4GALT6 | NM_004775.2 | Homo sapiens UDP-Gal:betaGlcNAc | 30 | 239 | |
| | GI:13929471 | beta-1,4-galactosyltransferase, | | | |
| | | polypeptide 6 | | | |
| B4GALT7 | NM_007255 | Homo sapiens xylosyl protein beta- | 31 | 240 | |
| | GI:6005951 | 1,4-galactosyltransferase, | | | |
| | | polypeptide 7 | | | |
| C1GALT1 | NM_020156 | Homo sapiens ‘core 1’ synthase, | 32 | 241 | |
| | GI:9910143 | glycoprotein-N-acetylgalactosamine | | | |
| | | 3-beta-galactosyltransferase, 1 | | | |
| C1GALT1C1 | NM_152692 | Homo sapiens C1GALT1-specific | 33 | 242 | 425 |
| | GI:58532585 | chaperon 1, transcript variant 1 | | | |
| CD44 | NM_000610 | Homo sapiens CD44 molecule (Indian | 202 | 243 | |
| | gi\|48255934\| | blood group), transcript variant 1 | | | |
| CD69 | NM_001781 | Homo sapiens CD69 molecule | 36 | 244 | 426 |
| | GI:4502680 | | | | |
| CDC2L1 | NM_033488-1 | Homo sapiens CDC2-like 1 (PITSLRE | 37 | 245 | |
| | GI:16332361 | Proteine), transcript variant 4 | | | |
| CDC2L2 | NM_024011 | Homo sapiens CDC2-like 2 (PITSLRE | 38 | 246 | |
| | GI:16357497 | proteins), transcript variant 1 | | | |
| CDH17 | NM_004063 | Homo sapiens cadherin 17, LI | 39 | 247 | |
| | GI:16507959 | cadherin (liver-intestine) | | | |
| CHPF | NM_024536 | Homo sapiens chondroitin | 191 | 248 | |
| | | polymerizing factor | | | |
| CHST4 | NM_005769 | Homo sapiens carbohydrate (N- | 40 | 249 | |
| | GI:5031734 | acetylglucosamine 6-O) | | | |
| | | sulfotransferase 4 | | | |
| CHST5 | NM_012126 | Homo sapiens carbohydrate (N- | 194 | 250 | |
| | GI:6912305 | acetylglucosamin 6-O) | | | |
| | | sulfotransferase 5 | | | |
| CHST6 | NM_021615 | human corneal N-acetylglucosamine | 41 | 251 | 427 |
| | GI:52851439 | 6-O sulfotransferase (hCGn6ST) | | | |
| CHST8 | NM_022467 | Homo sapiens carbohydrate (N- | 42 | 252 | |
| | GI:21361615 | acetylgalactosamin 4-0) | | | |
| | | sulfotransferase 8 | | | |
| CHST9 | NM_031422 | Homo sapiens carbohydrate (N- | 43 | 253 | |
| | GI:13899234 | acetylgalactosamin 4-0) | | | |
| | | sulfotransferase 9 | | | |
| CHSY1 | NM_014918 | Homo sapiens carbohydrate | 189 | 254 | |
| | | (chondroitin) synthase 1 | | | |
| CHSY-2/CSS1 | NM_175856 | Homo sapiens chondroitin synthase 2 | 181 | 255 | |
| CLEC2B | NM_0005127 | Homo sapiens C-type lectin domain | 397 | 256 | |
| | GI:37577106 | family 2, B | | | |
| CLEC7A | NM_197954 | Homo sapiens C-type lectin domain | 206 | 257 | |
| | GI:88999595 | family 7, A, transcript variant 6 | | | |
| CMAH | NR_002174 | Homo sapiens CMP-N- | 186 | 258 | |
| | GI:3800813 | acetylneuraminic acid hydroxylase | | | |
| | | mRNA | | | |
| CMAS | NM_018686 | Homo sapiens cytidine- | 44 | 259 | |
| | GI:22027483 | monophosphat N-acetylneuraminic | | | |
| | | acid synthetase | | | |
| CSGALNACT1 | NM_018371 | Homo sapiens chondroitin beta-,4 N- | 205 | 260 | |
| | | acetylgalactosaminyltransferase | | | |
| | | (ChGn) | | | |
| CSGALNACT2 | NM_018590 | Homo sapiens mRNA for beta-1,4-N- | 199 | 261 | |
| | | acetylgalactosaminyltransferase | | | |
| CSS2 | AB086062 | Homo sapiens mRNA for chondroitin | 193 | 262 | |
| | | sulfate synthase | | | |
| CXADR | NM_001338 | Homo sapiens Coxsackie virus and | 45 | 263 | 428 |
| | GI:45827793 | adenovirus receptor | | | |
| DPAGT1 | NM_203316 | Homo sapiens dolichyl phosphate | 46 | 264 | |
| | GI:42794010 | (UDP-N-Acetylglucosamine) N- | | | |
| | | acetylglucosamine | | | |
| | | phosphotransferase 1 (GlcNAc-1-P | | | |
| | | transferase) | | | |
| DSP | NM_004415 | Homo sapiens desmoplakin, | 47 | 265 | |
| | GI:58530839 | transcript variant 1 | | | |
| ECOP | NM_030798 | Homo sapiens EGFR-co-amplified | 178 | 266 | |
| | GI:31542523 | and over-expressed protein | | | |
| ETFB | NM_001985 | Homo sapiens electron transfer | 48 | 267 | 429 |
| | GI:62420878 | flavoprotein, beta polypeptide, | | | |
| | | transcript variant 1 | | | |
| FPGT | NM_003838 | Homo sapiens fucose-1-phosphate | 49 | 268 | |
| | | guanylyltransferase | | | |
| FUCA1 | NM_000147 | Homo sapiens fucosidase, alpha-L- 1, | 50 | 269 | 430 |
| | GI:24475878 | tissue | | | |
| FUCA2 | NM_032020 | Homo sapiens fucosidase, alpha-L- 2, | 182 | 270 | |
| | | plasma | | | |
| FucT1/SLC35C1 | NM_018389 | Homo sapiens ‘solute carrier’ | 187 | 271 | |
| | | family 35, C1, putative GDP-fucose | | | |
| | | transporter | | | |
| FUK | NM_145059 | Homo sapiens fucokinase | 51 | 272 | |
| FUT1 | NM_000148 | Homo sapiens fucosyltransferase 1 | 52 | 273 | 431 |
| | GI:58331243 | (galactoside 2-alpha-L- | | | |
| | | fucosyltransferase, blood group H) | | | |
| FUT10 | NM_032664 | Homo sapiens fucosyltransferase 10 | 53 | 274 | 432 |
| | GI:40805105 | (alpha (1,3) fucosyltransferase) | | | |
| FUT11 | NM_173540 | Homo sapiens fucosyltransferase 11 | 54 | 275 | |
| | GI:27734920 | (alpha (1,3) fucosyltransferase) | | | |
| FUT2 | NM_000511 | Homo sapiens fucosyltransferase 2 | 55 | 276 | 433 |
| | GI:56711329 | (including secretor status) | | | |
| FUT3 | NM_000149 | Homo sapiens fucosyltransferase 3 | 56 | 277 | 434 |
| | GI:4503808 | (galactoside 3(4)-L- | | | |
| | | fucosyltransferase, Lewis blood group) | | | |
| FUT4 | NM_002033 | Homo sapiens fucosyltransferase 4 | 57 | 278 | 435 |
| | GI:50845425 | (alpha (1,3) fucosyltransferase, | | | |
| | | myeloid specific) | | | |
| FUT5 | NM_002034 | Homo sapiens fucosyltransferase 5 | 58 | 279 | 436 |
| | GI:52485798 | (alpha (1,3) fucosyltransferase) | | | |
| FUT6 | NM_000150.1 | Homo sapiens fucosyltransferase 6 | 60 | 280 | 437 |
| | | (alpha (1,3) fucosyltransferase) | | | |
| FUT7 | NM_004479 | Homo sapiens fucosyltransferase 7 | 59 | 281 | |
| | GI:56090657 | (alpha (1,3) fucosyltransferase) | | | |
| FUT8 | NM_004480 | Homo sapiens fucosyltransferase 8 | 61 | 282 | 438 |
| | GI:30410721 | (alpha (1,6) fucosyltransferase), | | | |
| | | transcript variant 4 | | | |
| FUT9 | NM_006581 | Homo sapiens fucosyltransferase 9 | 62 | 283 | |
| | GI:36951077 | (alpha (1,3) fucosyltransferase) | | | |
| Fx/TSTA3 | NM_003313 | Homo sapiens tissue specific | 197 | 284 | |
| | | transplantation antigen P35B | | | |
| GAK | NM_005255 | Homo sapiens cyclin G-associated | 63 | 285 | |
| | GI:4885250 | kinase | | | |
| GAL3ST2 | NM_022134 | Homo sapiens galactose-3-O- | 61 | 286 | |
| | GI:11545866 | sulfotransferase 2 | | | |
| GALE | NM_001008216 | Homo sapiens UDP-galactose-4- | 65 | 287 | |
| | GI:56118216 | epimerase, transcript variant 2 | | | |
| GALNT1 | NM_020474 | Homo sapiens UDP-N-acetyl-alpha- | 66 | 288 | |
| | GI:13124890 | D-galactosamine: polypeptide N- | | | |
| | | acetylgalactosaminyltransferase | | | |
| | | (GalNAc-T) | | | |
| GALNT10 | NM_017540 | Homo sapiens UDP-N-acetyl-alpha- | 67 | 289 | |
| | GI:38788170 | D-galactosamine: polypeptide N- | | | |
| | | acetylgalactosaminyltransferase 10 | | | |
| | | (GalNAc-T10) | | | |
| GALNT11 | NM_022087 | Homo sapiens UDP-N-acetyl-alpha- | 68 | 290 | |
| | GI:11545800 | D-galactosamine: polypeptide N- | | | |
| | | acetylgalactosaminyltransferase 11 | | | |
| | | (GalNAc-T11) | | | |
| GALNT12 | NM_024642 | Homo sapiens UDP-N-acetyl-alpha- | 69 | 291 | |
| | GI:22203764 | D-galactosamine: polypeptide N- | | | |
| | | acetylgalactosaminyltransferase 12 | | | |
| | | (GalNAc-T12) | | | |
| GALNT13 | NM_052917 | Homo sapiens GALNT-13 mRNA for | 196 | 292 | |
| | | UDP-N-acetyl-apha-D- | | | |
| | | galactosamine: polypeptide | | | |
| | | N-acetylgalactosaminyltransferase | | | |
| | | 13, complete | | | |
| GALNT14 | NM_024572 | Homo sapiens UDP-N-acetyl-alpha- | 184 | 293 | |
| | | D-galactosamine: polypeptide N- | | | |
| | | acetylgalactosaminyltransferase 14 | | | |
| | | (GalNAc-T14) (GALNT14) | | | |
| GALNT15/ | NM_054110 | Homo sapiens UDP-N-acetyl-alpha- | 183 | 294 | |
| GALNTL2 | | D-galactosamine: polypeptide N- | | | |
| | | acetylgalactosaminyltransferase-like | | | |
| | | 2 | | | |
| GALNT17 | NM_001034845 | Homo sapiens GALNT17 mRNA for | 192 | 295 | |
| | | UDP-N-acetyl-alpha-D- | | | |
| | | galactosamine: polypeptide N- | | | |
| | | acetylgalactosaminyltransferase 17 | | | |
| GALNT2 | NM_004481 | Homo sapiens UDP-N-acetyl-alpha- | 70 | 296 | |
| | GI:9945385 | D-galactosamine: polypeptide N- | | | |
| | | acetylgalactosaminyltransferase | | | |
| | | (GalNAc-T) | | | |
| GALNT3 | NM_004482 | Homo sapiens UDP-N-acetyl-alpha- | 71 | 297 | |
| | GI:9945386 | D-galactosamine: polypeptide N- | | | |
| | | acetylgalactosaminyltransferase | | | |
| | | (GalNAc-T) | | | |
| GALNT4 | NM_003774 | Homo sapiens UDP-N-acetyl-alpha- | 72 | 298 | |
| | GI:34452724 | D-galactosamine: polypeptide N- | | | |
| | | acetylgalactosaminyltransferase 4 | | | |
| | | (GalNAc-T4) | | | |
| GALNT5 | NM_014568 | Homo sapiens UDP-N-acetyl-alpha- | 175 | 299 | |
| | | D-galactosamine: polypeptide N- | | | |
| | | acetylgalactosaminyltransferase 5 | | | |
| | | (GalNAc-T5) | | | |
| GALNT6 | NM_007210 | Homo sapiens UDP-N-acetyl-alpha- | 73 | 300 | |
| | GI:13124893 | D-galactosamine: polypeptide N- | | | |
| | | acetylgalactosaminyltransferase 6 | | | |
| | | (GalNAc-T6) | | | |
| GALNT7 | NM_017423 | Homo sapiens UDP-N-acetyl-alpha- | 74 | 301 | 439 |
| | GI:8393408 | D-galactosamine: polypeptide N- | | | |
| | | acetylgalactosaminyltransferase | | | |
| | | (GalNAc-T) | | | |
| GALNT8 | NM_017417 | Homo sapiens UDP-N-acetyl-alpha- | 75 | 302 | |
| | GI:8393411 | D-galactosamine: polypeptide N- | | | |
| | | acetylgalactosaminyltransferase 8 | | | |
| | | (GalNac-T8) | | | |
| GALNT9 | NM_021808 | Homo sapiens UDP-N-acetyl-alpha- | 76 | 303 | |
| | GI:38327555 | D-galactosamine: polypeptide N- | | | |
| | | acetylgalactosaminyltransferase 9 | | | |
| | | (GalNAc-T9) | | | |
| GALNTL1/ | NM_020692 | Homo sapiens UDP-N-acetyl-alpha- | 169 | 304 | |
| GALNT16 | | D-galactosamine: polypeptide N- | | | |
| | | acetylgalactosaminyltransferase-like | | | |
| | | 1 | | | |
| GALNTL4 | NM_198516 | Homo sapiens UDP-N-acetyl-alpha- | 83 | 305 | |
| | GI:38348337 | D-galactosamine: polypeptide N- | | | |
| | | acetylgalactosaminyltransferase-like | | | |
| | | 4 | | | |
| GALNTL5 | NM_145292 | Homo sapiens UDP-N-acetyl-alpha- | 173 | 306 | |
| | | D-galactosamine: polypeptide N- | | | |
| | | acetylgalactosaminyltransferase-like | | | |
| | | 5 | | | |
| GAPDH | NM_002046 | Homo sapiens glyceraldehyde-3- | 185 | 307 | 440 |
| | GI:83641890 | phosphate dehydrogenase | | | |
| GCNT1 | NM_001490 | Homo sapiens glucosaminyl (N- | 84 | 308 | 441 |
| | GI:34485725 | acetyl) transferase 1, ‘core’ 2 (beta- | | | |
| | | 1′,6-N-acetylglucosaminyltransferase) | | | |
| GCNT2 | NM_145649 | Homo sapiens glucosaminyl (N- | 468; 467 | 309 | 442 |
| | GI:85790494 and | acetyl) transferase 2, I-branching | | | |
| | NM_145655 | enzyme (blood group I) | | | |
| GCNT3 | NM_004751 | Homo sapiens glucosaminyl (N- | 85 | 310 | 443 |
| | GI:4758421 | acetyl) transferase 3, mucin type | | | |
| GCNT4 | NM_016591.1 | Homo sapiens glucosaminyl (N- | 77 | 311 | |
| | GI:7706126 | acetyl) transferase 4, ‘core’ 2 | | | |
| GLB1 | NM_000404 | Homo sapiens galactosidase, beta 1, | 86 | 312 | 444 |
| | GI:10834965 | transcript variant 179423 | | | |
| GNE | NM_005476 | Homo sapiens glucosamine (UDP-N- | 87 | 313 | 445 |
| | GI:38788307 | acetyl)-2-epimerase/N- | | | |
| | | acetylmannosamine kinase | | | |
| GNPTG | NM_032520 | Homo sapiens N-acetylglucosamine- | 88 | 314 | |
| | GI:42476109 | 1-phosphate transferase, gamma- | | | |
| | | subunit | | | |
| GPAA1 | NM_003801 | Homo sapiens homologue to GPAA1 | 89 | 315 | |
| | GI:83367079 | (glycosylphosphatidylinositol-anchor | | | |
| | | attachment protein 1) of yeast | | | |
| HDAC1 | NM_004964 | Homo sapiens histone deacetylase 1 | 90 | 316 | 446 |
| | GI:13128859 | | | | |
| HSP90AB1 | NM_007355 | Homo sapiens heat shock protein | 198 | 317 | |
| (HSPCB) | GI:20149593 | 90 kDa alpha (cytosolic), class B, 1 | | | |
| IGnT2 | AB078432 | Homo sapiens mRNA for beta-1,6-N- | 195 | 318 | |
| | | acetylglucosaminyltransferase 2 | | | |
| ITLN1 | NM_017625 | Homo sapiens intelectin 1 | 91 | 319 | |
| | GI:31542985 | (galactofuranose-binding) | | | |
| ITLN2 | NM_080878 | Homo sapiens intelectin 2 | 92 | 320 | |
| | GI:37622351 | | | | |
| KDELR1 | NM_006801 | Homo sapiens KDEL (Lys-Asp-Glu- | 93 | 321 | |
| | GI:32307173 | Leu) endoplasmic reticulum protein | | | |
| | | retention receptor 1 | | | |
| KDELR2 | NM_006854 | Homo sapiens KDEL (Lys-Asp-Glu- | 94 | 322 | |
| | GI:8051609 | Leu) endoplasmic reticulum protein | | | |
| | | retention receptor 2 | | | |
| KIAA0174 | NM_014761 | Homo sapiens KIAA0174 | 95 | 323 | |
| | GI:41281488 | | | | |
| LGALS1 | NM_002305 | Homo sapiens lectin, galactoside- | 96 | 324 | 447 |
| | GI:85815826 | binding, soluble, 1 (Galectin 1) | | | |
| LGALS10/ | NM_001828 | Homo sapiens Charcot-Leyden | 172 | 325 | |
| CLC | | crystal protein | | | |
| LGALS12 | NM_033101 | Homo sapiens lectin, galactoside- | 97 | 326 | |
| | GI:20127658 | binding, soluble, 12 (Galectin 12) | | | |
| LGALS13 | NM_013268 | Homo sapiens lectin, galactoside- | 98 | 327 | |
| | GI:20302163 | binding, soluble, 13 (Galectin 13) | | | |
| LGALS14 | NM_020129 | Homo sapiens lectin, galactoside- | 99 | 328 | |
| | GI:45439323 | binding, soluble, 14 transcript | | | |
| | | variant 1 | | | |
| LGALS2 | NM_006498 | Homo sapiens lectin, galactoside- | 100 | 329 | |
| | GI:51173752 | binding, soluble, 2 (Galectin 2) | | | |
| LGALS3 | NM_002306 | Homo sapiens lectin, galactoside- | 101 | 330 | 448 |
| | GI:4504982 | binding, soluble, 3 (Galectin 3) | | | |
| LGALS3BP | NM_005567 | Homo sapiens lectin, galactoside- | 102 | 331 | |
| | GI:6006016 | binding, soluble, 3 Bindeprotein | | | |
| LGALS4 | NM_006149 | Homo sapiens lectin, galactoside- | 103 | 332 | |
| | GI:6006017 | binding, soluble, 4 (Galectin 4) | | | |
| LGALS7 | NM_002307 | Homo sapiens lectin, galactoside- | 104 | 333 | 449 |
| | GI:4504984 | binding, soluble, 7 (Galectin 7) | | | |
| LGALS8 | NM_006499 | Homo sapiens lectin, galactoside- | 105 | 334 | |
| | GI:42544184 | binding, soluble, 8 (Galectin 8) | | | |
| LGALS9 | NM_002308 | Homo sapiens lectin, galactoside- | 106 | 335 | 450 |
| | GI:6806891 | binding, soluble, 9 (Galectin 9) | | | |
| LLGL2 | NM_004524 | Homo sapiens ‘lethal giant larvae’ | 107 | 336 | 451 |
| | GI:62739160 | homologue 2 (Drosophila), transcript | | | |
| | | variant 1 | | | |
| LYPLA2 | NM_007260 | Homo sapiens lysophospholipase II | 108 | 337 | |
| | GI:20302149 | | | | |
| MAPKAPK2 | NM_004759 | Homo sapiens mitogen-activated | 109 | 338 | |
| | GI:32481207 | protein kinase-activated protein | | | |
| | | kinase 2, transcript variant 1 | | | |
| MGAT1 | NM_002406 | Homo sapiens mannosyl (alpha-1,3-)- | 110 | 339 | |
| | GI:6031182 | glycoprotein beta-1,2-N- | | | |
| | | acetylglucosaminyltransferase | | | |
| MGAT3 | NM_002409 | Homo sapiens mannosyl (beta-1,4-)- | 111 | 340 | |
| | GI:19924166 | glycoprotein beta-1,4-N- | | | |
| | | acetylglucosaminyltransferase | | | |
| MGAT4A | NM_012214.2 | Homo sapiens mannosyl (alpha-1,3-)- | 166 | 341 | |
| | | glycoprotein beta-1,4-N- | | | |
| | | acetylglucosaminyltransferase, | | | |
| | | isozyme A, mRNA | | | |
| MGAT4B | NM_054013 | Homo sapiens mannosyl (alpha-1,3-)- | 112 | 342 | |
| | GI:83267864 | glycoprotein beta-1,4-N- | | | |
| | | acetylglucosaminyltransferase, | | | |
| | | isozyme B, transcript variant 2 | | | |
| MGAT5 | NM_002410 | Homo sapiens mannosyl (alpha-1,6-)- | 113 | 343 | 452 |
| | GI:6031185 | glycoprotein beta-1,6-N- | | | |
| | | acetylglucosaminyltransferase | | | |
| MGRN1 | NM_015246 | Homo sapiens Mahogunin, Ringfinger | 114 | 344 | |
| | GI:44917607 | 1 | | | |
| NAGK | NM_017567 | Homo sapiens N-acetylglucosamine- | 79 | 345 | |
| | GI:49574507 | kinase, mRNA. | | | |
| NANS | NM_018946 | Homo sapiens N-acetylneuramininic | 115 | 346 | |
| | GI:12056472 | acid synthase (sialic acid synthase) | | | |
| NDST1 | NM_001543 | Homo sapiens N-deacetylase/N- | 116 | 347 | 453 |
| | GI:46094001 | sulfotransferase (heparan | | | |
| | | glucosaminyl) 1 | | | |
| NEU1 | NM_000434 | Homo sapiens sialidase 1 (lysosomal | 117 | 348 | 454 |
| | GI:40806202 | sialidase) | | | |
| NEU2 | NM_005383 | Homo sapiens sialidase 2 (cytosolic | 118 | 349 | |
| | GI:4885514 | sialidase) | | | |
| NEU3 | NM_006656 | Homo sapiens sialidase 3 (membrane | 119 | 350 | |
| | GI:21704286 | sialidase) | | | |
| NEU4 | NM_080741 | Homo sapiens sialidase 4 | 171 | 351 | |
| NPL | NM_030769 | Homo sapiens N-acetylneuraminate- | 78 | 352 | |
| | GI:13540532 | pyruvate lyase (dihydrodipicolinate | | | |
| | | synthase) | | | |
| O-acetyl- | AF300796.1 | Homo sapiens sialic acid specific | 168 | 353 | |
| esterase | GI:10242344 | 9-O-acetylesterase I mRNA | | | |
| OGT | NM_181673.1 | Homo sapiens O-linked N- | 167 | 354 | |
| | | acetylglucosamin (GlcNAc) | | | |
| | | transferase (UDP-N- | | | |
| | | acetylglucosamine: polypeptide-N- | | | |
| | | acetylglucosaminyl transferase), | | | |
| | | transcript variant 2, mRNA | | | |
| PGM3 | NM_015599 | Homo sapiens phosphoglucomutase | 80 | 355 | |
| | GI:7661567 | 3 | | | |
| POFUT1 | NM_015352 | Homo sapiens protein O- | 176 | 356 | |
| | | fucosyltransferase 1 | | | |
| POFUT2 | NM_015227 | Homo sapiens protein O- | 177 | 357 | |
| | | fucosyltransferase 2 | | | |
| POMGNT1 | NM_017739 | Homo sapiens O-linked | 82 | 358 | |
| (FLJ20277) | GI:116686123 | mannose beta 1,2-N- | | | |
| | | acetylglucosaminyltransferase | | | |
| PPIA | NM_021130 | Homo sapiens peptidylprolyl- | 120 | 359 | 455 |
| | GI:45439309 | isomerase A (cyclophilin A), transcript | | | |
| | | variant 1 | | | |
| RABGAP1L | NM_014857 | Homo sapiens RAB GTPase | 121 | 360 | |
| | GI:78217385 | activating protein 1-like, transcript | | | |
| | | variant 1 | | | |
| RENBP | NM_002910.4 | Homo sapiens renin binding protein | 81 | 361 | |
| | GI:11496987 | | | | |
| RERE | NM_012102 | Homo sapiens arginine-glutamic acid | 122 | 362 | |
| | GI:19923392 | dipeptide (RE) repeats | | | |
| RNASE4 | NM_002937 | Homo sapiens ribonuclease, RNase | 123 | 363 | |
| | GI:37577173 | A family, 4, transcript variant 2 | | | |
| RPL13A | NM_012423 | Homo sapiens ribosomal protein L13a | 124 | 364 | |
| | GI:14591905 | | | | |
| SELE | NM_000450 | Homo sapiens selectin E (endothelial | 125 | 365 | 456 |
| | GI:4506870 | adhesion molecule 1) | | | |
| SELL | NM_000655 | Homo sapiens selectin L (lymphocytic | 126 | 366 | 457 |
| | GI:5713320 | adhesion molecule 1) | | | |
| SELP | NM_003005 | Homo sapiens selectin P (granule | 127 | 367 | |
| | GI:6031196 | membrane protein 140 kDa, antigen | | | |
| | | CD62) | | | |
| SIAE/ | NM_170601 | Homo sapiens sialic acid | 465 | 369 | |
| OAE | | acetylesterase | | | |
| SIGLEC1/ | NM_023068 | Homo sapiens sialic acid-binding Ig- | 170 | 370 | |
| CD169 | | like lectin 1, sialoadhesin | | | |
| SIGLEC10 | NM_033130 | Homo sapiens sialic acid-binding Ig- | 129 | 371 | |
| | GI:31377638 | like lectin 10 | | | |
| SIGLEC11 | NM_052884 | Homo sapiens sialic acid-binding Ig- | 130 | 372 | |
| | GI:16418392 | like lectin 11 | | | |
| SIGLEC12 | NM_053003 | Homo sapiens sialic acid-binding Ig- | 131 | 373 | |
| | GI:24497436 | like lectin 12, transcript variant 1 | | | |
| SIGLEC2/ | NM_001771 | Homo sapiens CD22 molecule | 34 | 374 | 458 |
| CD22 | GI:4502650 | | | | |
| SIGLEC3/ | NM_001772 | Homo sapiens CD33 molecule | 35 | 375 | 459 |
| CD33 | GI:50726999 | | | | |
| SIGLEC5 | NM_003830 | Homo sapiens sialic acid-binding Ig- | 132 | 376 | |
| | GI:4502658 | like lectin 5 | | | |
| SIGLEC6 | NM_198845 | Homo sapiens sialic acid-binding Ig- | 133 | 377 | |
| | GI:87298829 | like lectin 6, transcript variante 2 | | | |
| SIGLEC7 | NM_016543 | Homo sapiens sialic acid -binding Ig- | 134 | 378 | |
| | GI:7706570 | like lectin 7, transcript variant 2 | | | |
| SIGLEC8 | NM_014442 | Homo sapiens sialic acid -binding Ig- | 135 | 379 | |
| | GI:7657571 | like lectin 8 | | | |
| SIGLEC9 | NM_014441 | Homo sapiens sialic acid -binding Ig- | 136 | 380 | |
| | GI:23943855 | like lectin 9 | | | |
| SLC2A1 | NM_006516 | Homo sapiens ‘solute carrier’ family | 137 | 381 | |
| | GI:5730050 | 2 (facilitated glucose transporter), 1 | | | |
| SLC35A1 | NM_006416 | Homo sapiens ‘solute carrier’ family | 138 | 382 | |
| | GI:20149579\| | 35 (CMP- sialic acid transporter), A1 | | | |
| SLC35A2 | NM_005660 | Homo sapiens ‘solute carrier’ family | 139 | 383 | |
| | GI:5032210 | 35 (UDP-galactose transporter), A2, | | | |
| | | transcript variante 1 | | | |
| SLC35A3 | NM_012243 | Homo sapiens ‘solute carrier’ family | 140 | 384 | |
| | GI:6912667 | 35 (UDP-N-acetylglucosamine (UDP- | | | |
| | | GlcNAc) transporter), A3 | | | |
| SLC35D1 | NM_015139 | Homo sapiens ‘solute carrier’ family | 141 | 385 | |
| | GI:14028874 | 35 (UDP-glucuronic acid/UDP-N- | | | |
| | | acetylgalactosamine dual | | | |
| | | transporter), D1 | | | |
| ST3GAL1 | NM_003033 | Homo sapiens ST3 beta-galactoside | 142 | 386 | |
| | GI:27765097 | alpha-2,3-sialyltransferase 1, | | | |
| | | transcript variant 1 | | | |
| ST3GAL2 | NM_006927 | Homo sapiens ST3 beta-galactoside | 143 | 387 | |
| | GI:27765098 | alpha-2,3-sialyltransferase 2 | | | |
| ST3GAL3 | NM_006279 | Homo sapiens ST3 beta-galactoside | 144 | 388 | |
| | GI:28373066 | alpha-2,3-sialyltransferase 3, | | | |
| | | transcript variant 10 | | | |
| ST3GAL4 | NM_006278 | Homo sapiens ST3 beta-galactoside | 145 | 389 | 460 |
| | GI:5454057 | alpha-2,3-sialyltransferase 4 | | | |
| ST3GAL5 | NM_003896 | Homo sapiens ST3 beta-galactoside | 146 | 390 | |
| | GI:28373079 | alpha-2,3-sialyltransferase 5 | | | |
| ST3GAL6 | NM_006100 | Homo sapiens ST3 beta-galactoside | 147 | 391 | |
| | GI:31377787 | alpha-2,3-sialyltransferase 6 | | | |
| ST6GAL1 | NM_003032 | Homo sapiens ST6 beta-galactosamide | 148 | 392 | |
| | GI:27765094 | alpha-2,6-sialyltranferase 1, | | | |
| | | transcript variant 2 | | | |
| ST6GAL2 | NM_032528 | Homo sapiens ST6 Beta-Galactosamid | 149 | 393 | |
| | GI:26190609 | Alpha-2,6-Sialyltranferase 2 | | | |
| ST6GALNAC1 | NM_018414 | Homo sapiens ST6 (alpha-N-acetyl- | 150 | 394 | |
| | GI:90403587 | neuraminyl-2,3-beta-galactosyl-1,3)- | | | |
| | | N-acetylgalactosaminide alpha-2,6- | | | |
| | | sialyltransferase 1 | | | |
| ST6GALNAC2 | NM_006456 | Homo sapiens ST6 (alpha-N-acetyl- | 151 | 395 | 461 |
| | GI:5454091 | neuraminyl-2,3-beta-galactosyl-1,3)- | | | |
| | | N-acetylgalactosaminide alpha-2,6- | | | |
| | | sialyltransferase 2 | | | |
| ST6GALNAC3 | NM_152996 | Homo sapiens ST6 (alpha-N-acetyl- | 152 | 396 | |
| | GI:23308723 | neuraminyl-2,3-beta-galactosyl-1,3)- | | | |
| | | N-acetylgalactosaminid alpha-2,6- | | | |
| | | sialyltransferase 3 | | | |
| ST6GALNAC5 | NM_030965 | Homo sapiens ST6 (alpha-N-acetyl- | 153 | 398 | |
| | GI:13569937 | neuraminyl-2,3-beta-galactosyl-1,3)- | | | |
| | | N-acetylgalactosaminid alpha-2,6- | | | |
| | | sialyltransferase 5 | | | |
| ST6GALNAC6 | NM_013443 | Homo sapiens ST6 (alpha-N-acetyl- | 154 | 399 | |
| | GI:34147672 | neuraminyl-2,3-beta-galactosyl-1,3)- | | | |
| | | N-acetylgalactosaminid alpha-2,6- | | | |
| | | sialyltransferase 6 | | | |
| ST8SIA1 | NM_003034 | Homo sapiens ST8 alpha-N-acetyl- | 155 | 400 | |
| | GI:28373095 | neuraminide alpha-2,8- | | | |
| | | sialyltransferase 1 | | | |
| ST8SIA2 | NM_006011 | Homo sapiens ST8 alpha-N-acetyl- | 156 | 401 | |
| | GI:59806358 | neuraminid alpha-2,8- | | | |
| | | sialyltransferase 2 | | | |
| ST8SIA3 | NM_015879 | Homo sapiens ST8 alpha-N-acetyl | 157 | 402 | |
| | GI:7705667 | neuraminide alpha-2,8- | | | |
| | | sialyltransferase 3 | | | |
| ST8SIA4 | NM_005668 | Homo sapiens ST8 alpha-N-acetyl- | 158 | 403 | |
| | GI:38202228 | neuraminide alpha-2,8- | | | |
| | | sialyltransferase 4, | | | |
| | | transcript variant 1 | | | |
| ST8SIA5 | NM_013305 | Homo sapiens ST8, alpha-N-acetyl- | 159 | 404 | |
| | GI:59806359 | neuraminide alpha-2,8- | | | |
| | | sialyltransferase 5 | | | |
| ST8SIA6 | NM_001004470 | Homo sapiens ST8 alpha-N-acetyl- | 160 | 405 | |
| | | neuraminide alpha-2,8- | | | |
| | | sialyltransferase 6 | | | |
| SULT1C2 | NM_001056 | Homo sapiens sulfotransferase | 203 | 406 | 462 |
| | GI:45935387 | family, cytosolic, 1C, family member | | | |
| | | 1, transcript variant 1 | | | |
| SULT1C4 | NM_006588 | Homo sapiens sulfotransferase | 201 | 407 | |
| | GI:28830307 | family, cytosolic, 1C, family member | | | |
| | | 2 | | | |
| TACSTD1 | NM_002354 | Homo sapiens tumour-associated | 163 | 408 | |
| | GI:4505058 | calcium signal transducer 1 | | | |
| TAF15 | NM_003487 | Homo sapiens TAF15 RNA | 164 | 409 | |
| | GI:21327699 | polymerase II, TATA box binding | | | |
| | | protein (TBP)-associated factor, | | | |
| | | 68 kDa, transcript variant 2 | | | |
| TAX1BP1 | NM_006024 | Homo sapiens Tax1 (human T-cell | 165 | 410 | |
| | GI:21361681 | leukaemia virus type I) binding protein | | | |
| | | 1 | | | |
| TNFRSF1B | NM_001066 | Homo sapiens tumour necrosis factor | 162 | 411 | 463 |
| | GI:23312365 | receptor superfamily, 1B | | | |
| TUBA3C | NM_006001 | Homo sapiens tubulin, alpha 2, | 204 | 412 | 464 |
| | GI:17921992 | transcript variant 1 | | | |
| TUBA4 | NR 003063 | Homo sapiens tubulin, alpha 4 | 200 | 200 | 413 |
| | GI:95113641 | | | | |
| UAP1 | NM_003115 | Homo sapiens UDP-N- | 161 | 161 | 414 |
| | GI:34147515 | acteylglucosamine | | | |
| | | pyrophosphorylase 1 | | | |
| WBSCR1/ | NM_022170 | Homo sapiens Williams-Beuren | 190 | | 415 |
| EIF4H | GI:11559922 | syndrome chromosome region 1, | | | |
| | | transcript variant 1 | | | |
| WBSCR17/ | NM_022479 | Homo sapiens Williams-Beuren | 174 | 174 | 416 |
| GALNTL3 | | syndrome chromosome region 17 | | | |
| | | (WBSCR17) | | | |

In column four of the Table, the corresponding SEQ ID numbers are assigned to the genes described. Furthermore, in column five (SEQ ID NO Oligo 1) and six (SEQ ID NO Oligo 2), the corresponding SEQ ID numbers of preferred oligonucleotides are assigned to the genes in question.

In a further preferred embodiment of the support of the invention, the probes are selected from the preferred oligonucleotides listed in Table 1.

In a further preferred embodiment each of the proteins of Table 1 is represented by at least one probe on the support.

The invention further relates to a kit, comprising the set of probes as defined above. In a preferred embodiment, the kit according to the invention comprises at least one probe each for the proteins mentioned in Table 1. The probes contained in the kit can be used for the production of a support, for example of the support according to the invention, and also as probes in hybridisation methods such as e.g. Southern Blotting or Northern Blotting. These methods per se are well-known in the art.

The present invention also relates to the use of the support or kit according to the invention for the quantitative determination of the expression of nucleic acids encoding fucosyltransferases, galactosyltransferases, N-acetylglucosaminyl transferases, N-acetylgalactosaminyl transferases, sialyltransferases, sugar sulfotransferases, lectins, selectins, fucosidases, neuraminidases (sialidases), nucleotide sugar epimerases, sugar kinases, sugar epimerases, sugar transporters and enzymes of the fucose or sialic acid metabolism, in a sample obtained from a cell, a tissue or an organism.

In accordance with the present invention, the term quantitative determination refers to the measuring of the amount of a target molecule or a value proportional thereto. This amount can be stated as an absolute value (e.g. the signal intensity of the target molecule) or as a ratio. The presentation of the quantity in form of a ratio, e.g. between the signal intensities of the target molecule and a control molecule analysed in parallel offers crucial advantages. For example, experiments can be compared with each other that were carried out at different times, under different conditions, with different methods or different starting material. Methods for the analysis and determination of expression data are known to the person skilled in the art.

In accordance with the present invention, the term a sample obtained from a cell, a tissue or an organism refers to a sample which is obtained from cells, tissues or an organism by means of, for example, methods known in the art. For example, a sample can be taken from a living organism by means of biopsy. In addition, methods such as e.g. laser capture microdissection can be used to isolate individual cells. These methods per se are well-known in the art, as described e.g. in Kamme et al., 2003. Subsequently, the thus obtained cells and/or tissues as well as cells from cell cultures can be lysed by methods known to the person skilled in the art. By means of these methods, samples can be obtained, for example, from a single cell. However, samples can also be obtained from a greater number of cells, for example 10³ to 10⁵ cells.

Furthermore, the invention relates to a method for the quantitative determination of the expression of nucleic acids encoding fucosyltransferases, galactosyltransferases, N-acetylglucosaminyl transferases, N-acetylgalactosaminyl transferases, sialyltransferases, sugar sulfotransferases, lectins, selectins, fucosidases, neuraminidases (sialidases), nucleotide sugar epimerases, sugar kinases, sugar epimerases, sugar transporters and enzymes of the fucose or sialinic acid metabolism, comprising the steps of contacting the support according to the invention with a preparation of labelled nucleic acids obtained by reverse transcription of mRNAs that are present in a sample obtained from a cell, a tissue or an organism, and quantifying the amount of labelling bound to the probes on the support.

In this context, labelled nucleic acids include, among others, cDNAs or cRNAs which have a detectable label, for example a radioactive or a luminescent or fluorescent label, or which are biotinylated. The production of labelled cDNAs is well-known to the person skilled in the art and is described, for example, in Manduchi et al., 2002. For example labelled nucleotides can be introduced directly into the resulting cDNA during the reverse transcription of RNA, or specific reactive nucleotides are introduced which, in a second step, are linked to a label (e.g. indirect amino allyl cDNA labelling), or cDNAs can be equipped with a so-called “capture sequence” which facilitates labelling of the cDNAs already bound to the array by means of fluorescent dendrimers (e.g. Genisphere 3DNA Array labelling kits). The production of labelled cRNAs is also well-known to the person skilled in the art. For example, mRNA is used as a template for cDNA synthesis which, after purification, is transcribed into cRNA in an in vitro transcription with labelled ribonucleotides. Frequently used labels include, for example, the fluorescent labels Cy3, Cy5, Alexa Fluor 546 or Alexa Fluor 647, as well as P³²-labelled nucleotides for direct labelling in the case of radioactive labelling. In this context, different samples can be labelled with different labels (e.g. different fluorescent markers) and, subsequently be contacted with a common support (dual colour labelling) or the same label (for example biotin) can be used for all samples, in which case each sample is contacted with a separate support (single colour labelling).

A preferred embodiment of the method according to the invention further comprises the determination of the expression of nucleic acids encoding fucosyltransferases, galactosyltransferases, N-acetylglucosaminyl transferases, N-acetylgalactosaminyl transferases, sialyltransferases, sugar sulfotransferases, lectins, selectins, fucosidases, neuraminidases (sialidases), nucleotide sugar epimerases, sugar kinases, sugar epimerases, sugar transporters and enzymes of the fucose or sialinic acid metabolism, wherein the determination of the expression comprises: (i) determination of the amount of mRNA by PCR, Ribonuclease Protection Assay or SAGE (Serial Analysis of Gene Expression); and/or (ii) determination of the amount of protein.

Thus, in accordance with this preferred embodiment, the determination of the expression by means of the support or kit according to the invention is enriched by further expression data which are determined by means of other methods.

Methods for the determination of the amount of mRNA by PCR as such are well-known to the person skilled in the art and include, for example, real-time PCR and real competitive PCR. Methods for the determination of the amount of mRNA by Ribonuclease Protection Assay or SAGE as such are well-known in the art and are described, for example, in Ding and Cantor, 2004.

In a further preferred embodiment of the method according to the invention, the determination of the expression of the fucosyltransferases, galactosyltransferases, N-acetylglucosaminyl transferases, N-acetylgalactosaminyl transferases, sialyltransferases, sugar sulfotransferases, lectins, selectins, fucosidases, neuraminidases, sialidases, nucleotide sugar epimerases, sugar kinases, sugar epimerases, sugar transporters and enzymes of the fucose or sialinic acid metabolism takes place by means of antibodies or aptamers that are specific for the fucosyltransferases, galactosyltransferases, N-acetylglucosaminyl transferases, N-acetylgalactosaminyl transferases, sialyltransferases, sugar sulfotransferases, lectins, selectins, fucosidases, neuraminidases, sialidases, nucleotide sugar epimerases, sugar kinases, sugar epimerases, sugar transporters and enzymes of the fucose or sialinic acid metabolism.

The term “antibody” in accordance with the invention comprises specific antibodies or antibody fragments or antibody derivatives. Fragments of antibodies include e.g. Fab or F(ab′)₂ fragments. Derivatives include scFvs. Methods for the generation of specific antibodies are known in the art. Standard detection methods wherein antibodies are used are, as already mentioned above, among others ELISA, RIA or also protein arrays, but also immunofluorescence, flow cytometry and other detection methods. In this context, the antibodies bind specifically to the target molecules. The antibody binding can be made visible by e.g. labelling of the primary antibodies or is detected by means of secondary antibodies that bind the antibody, and that are in this case labelled themselves. The antibodies can be modified with e.g. fluorescent substances, radioactive labelling or an enzymatic label. Immunological detection methods using specific antibodies are known in the art (e.g. Harlow et al., 1988) and include, for example, Western Blotting, ELISA, RIA, protein arrays, immunofluorescence or flow cytometry. Suitable antibodies according to the invention are, for example but not exclusively, CD22 antibodies, antibodies against Thomsen-Friedenreich glycotope as well as antibodies for sialyl Lewis X and sialyl Lewis A antigens.

The term “aptamer” according to the invention comprises nucleic acids that, due to their three-dimensional structure, bind to a target molecule. Aptamers per se are known in the art, e.g. in Osborne et al., 1997.

In a preferred embodiment of the use according to the invention or the method according to the invention, the expression shows the glycosylation status of the cell, the tissue or the organism.

Glycosylation status refers to the number and kind of sugar side chains of proteins on/in a cell. The knowledge about the condition of the glycosylation apparatus, which is gained by means of the expression analysis, enables a correlation with the glycosylation status of a cell. For example, the knowledge about a reduced expression of the enzyme UDP-N-acetylglucosamine-2-epimerase/N-acetylmannosamine-kinase (GNE)—the key enzyme of sialic acid synthesis—enables a correlation to the density of sialic acid on the cell surface.

The use of the expression data according to the invention for the analysis of the glycosylation status can be used, for example, for the profiling of cell lines for the production of glycosylated biopharmaceuticals. By means of the array, the selection of the optimum cell line for the biosynthesis of a desired glycan structure is facilitated. Furthermore, it can be tested whether enzymes are expressed which can reduce or prevent the synthesis of a desired glycan structure.

The analysis of expression patterns according to the invention is also advantageous with regard to testing of the effects of glycoengineering. Often, cell lines have to be subjected to additional glycoengineering either to enhance specific glycosyl transferase activities and/or to reduce or eliminate other activities e.g. by means of siRNA technology. The success of this glycoengineering and the potential additional changes of the expression profile associated therewith can be analysed by means of the method according to the invention.

The effect of changes in cell culture parameters such as e.g. serum deprivation or changes in the O₂ and/or CO₂ gas concentration can be observed since they have an important impact on the glycolisation pattern of product cell lines. Additionally or alternatively, the expression patterns can also serve for the process monitoring of the constancy of cell cultivation processes during the production phase.

In a further preferred embodiment of the use according to the invention or the method according to the invention, the expression indicates the disease state, the malignancy and/or the potential of formation of metastase of the cell, the tissue or the organism.

The term malignancy according to the invention describes a course of disease which has a progressive destructive effect and, potentiallly, can lead to death. In connection with tumour diseases, malignancy relates to the capability of a tumour to penetrate the basal membrane and form metastases. A tumour of that kind is colloquially referred to as cancer. Depending on the capability of tumours/tumour cells to develop such metastases, a differentiation is made between low malignant and highly malignant tumours.

The term potential of formation of metastase refers to the capability of cells (in general tumour cells) to lose connectivity to the surrounding tissue. During this loss of connectivity, groups of cells can detach and emigrate. An additional defect of the adhesion molecules on the surface of (malignant) cells that are essential for the connectivity of cells facilitates the emigration additionally.

By means of the use according to the invention or the method according to the invention, for example expression profiles of carcinomas with different prognoses can be obtained and the expression data can be correlated with categories such as the metastasis of the carcinoma and the survival period of the patient, so that a prognoses can be given for other patients. Thus, array-based profiling of tumour-expressed glycosylation enzymes represents an innovative technology for diagnostics or therapy prognoses.

For all these uses and methods, the present invention offers highly parallel and quickly to perform alternatives to the elaborate glycan analyses.

The invention further relates to a diagnostic composition comprising the set of probes as defined above.

The invention further relates to the use of the set of probes according to the invention for the preparation of one or more diagnostic compositions or of a diagnostic device for the diagnosis of tumours, inflammatory and/or neurological diseases.

The measurement of the activity of enzymes, the activity of which regulates the glycosylation in a tissue- and differentiation-specific way, can be used for diagnostic purposes. In addition, also the mRNA expression of these glycogens can be of diagnostic value. For example, it is known that specific acidic sugars (sialic acids) occur more strongly in the glycan structures of metastasising tumour cells. In accordance with this, also the expression of the enzyme catalysing the formation of these structures (sialyltransferase ST6Gal-1) is increased in metastasising colorectal carcinomas (Dall'Olio et al., 1989; Kemmner et al., 1994). Similar results were found in analyses of stomach, kidney, prostate and mamma carcinomas (see Table 2).

The immune defence also depends on a regulated activation of glycosyltransferases. Investigations show that the expression profile of different glycosyltransferases changes during the development of T-lymphocytes in a temporally and spacially controlled manner (Baum, 2002). For example, the sugar sequence NeuAca2,6Gal, the product of the ST6Gal-I sialyltransferase, is only found on mature medullary thymocytes. Moreover, glycosylation also plays an important role for the activation of the HIV virus (Lefebvre et al., 1994) or the infection of epithelia cells by influenza viruses (Stevens et al., 2006).

Another highly glycosylated protein is the prion protein which is made responsible for spongiform encephalopathies, such as bovine spongiform encephalopathy (BSE) in cattle and Creutzfeld-Jakob disease in humans. Glycosylation is one of the factors controlling the conversion of the “normal” protein into the disease-causing form and depends on the relative activities of the glycosyltransferases of the host cell.

Moreover, changes of the expression pattern of glycogens were detected in Alzheimer's disease, neuromuscular and hereditary diseases (CGD), which e.g. lead to mental retardation.

Table 2 summarises important studies which show how the expression patterns of these glycogens differ in different clinical pictures.

As already defined above, the term tumour according to the invention refers to new formation of body tissues (neoplasia) occurring due to a dysregulation of cell growth. Differentiation is made between benign and malignant tumours.

As already defined above, inflammatory diseases according to the invention are diseases which represent a first reaction of the immune system to infections or stimuli such as e.g. physical stimuli, microorganisms, allergens, toxins or dysfunctional enzymes, which have-the function to remove or to repair the damaging stimulus. Frequently occurring diseases include e.g. arthritis, myocarditis, dermatitis, otitis, pneumonia, rheumatoid diseases, Crohn's disease, ulcerative colitis, spondylitis, osteoarthritis or psoriasis.

As already defined above, neurological diseases according to the invention refer to diseases of the nervous system. The organ systems concerned are the central nervous system and the peripheral nervous system including the surrounding structures. Neurological diseases include e.g. multiple sclerosis, cerebral meningitis, inflammations of the spinal cord, cerebral infarct, Parkinson's disease, brain tumours, migrane, epilepsy, dementias and muscle dystrophies.

TABLE 2
Expression patterns of glyogens in different clinical pictures.

| Disease | Publication |
|---|---|
| Alzheimer's | B. Espinosa et al.; 2001; J. Neuropathol. Exp. Neurol. |
| disease | 60(5): 441. |
| | Y. Huang et al.; 2004; Eur. J. Neurosci. 20(12): 3489. |
| | L. A. Robertson et al.; 2004; J. Alzheimers. Dis. |
| | 6(5): 489. |
| Cancer | F. Schneider et al.; 2001; Cancer Res. 61(11): 4605. |
| diseases | E. Y. Song et al.; 2001; Cancer Invest 19(8): 799. |
| | T. Petretti et al.; 2000; Gut 46(3): 359. |
| | T. Takahashi et al.; 2000; Int. J. Cancer 88(6): 914. |
| | I. Brockhausen; 1999; Biochim. Biophys. Acta |
| | 1473(1): 67. |
| | J. Burchell et al.; 1999; Glycobiology. 9(12): 1307. |
| | J. W. Dennis et al.; 1999; Biochim. Biophys. Acta |
| | 1473(1): 21. |
| | T. F. Orntoft and E. M. Vestergaard; 1999; |
| | Electrophoresis 20(2): 362. |
| | T. Petretti et al.; 1999; Biochim. Biophys. Acta |
| | 1428(2-3): 209. |
| | T. Kudo et al.; 1998; Lab. Invest. 78(7): 797. |
| | H. Ito et al.; 1997; Int. J. Cancer 71(4): 556. |
| | G. Sotiropoulou et al.; 2002; Mol. Med. 8(1): 42. |
| | S. Saito et al.; 2002; Oncol. Rep. 9(6): 1251. |
| | Y. Ide et al.; 2006; Biochem. Biophys. Res. Commun. |
| | 341(2): 478. |
| | X. L. Jin et al.; 2004; Hepatobiliary. Pancreat. |
| | Dis. Int. 3(2): 292. |
| Hereditary | J. Jaeken and G. Matthijs; 2001; Annu. Rev. Genomics |
| diseases | Hum. Genet. 2: 129. |
| | B. S. Miller and H. H. Freeze; 2003; Rev. Endocr. |
| | Metab Disord. 4(1): 103. |
| | E. A. Eklund and H. H. Freeze; 2006; NeuroRx. |
| | 3(2): 254. |
| | L. Sturla et al.; 2005; Glycobiology 15(10): 924. |
| | E. Martin-Rendon and D. J. Blake; 2003; Trends |
| | Pharmacol. Sci. 24(4): 178. |
| Diseases of the | J. B. Lowe; 2001; Cell 104(6): 809. |
| immune system | G. Alvarez et al.; 1999; Immunol. Invest. 28(1): 9. |
| | J. S. Axford; 1999; Biochim. Biophys. Acta |
| | 1455(2-3): 219. |
| | P. J. Delves; 1998; Autoimmunity 27(4): 239. |
| | L. Galli Stampino et al.; 1997; Cancer Res. |
| | 57(15): 3214. |
| | A. Orlacchio et al.; 1997; J. Neurol. Sci. |
| | 151(2): 177. |
| | J. C. Lefebvre et al.; 1994; Virology 199: 265. |
| | T. Feizi and M. Larkin; 1990; Glycobiology |
| | 1(1): 17. |
| | [Erratum in Glycobiology 1991 June; 1(3): 315]. |
| | M. Demetriou et al.; 2001; Nature 409(6821): 733. |
| | M. Bunting et al.; 2002; Curr. Opin. Hematol. |
| | 9(1): 30. |
| | E. I. Buzas et al.; 2006; Autoimmunity 39(8): 691. |
| | M. Lanteri et al.; 2003; Glycobiology 13(12): 909. |
| Muscle | A. Yoshida et al.; 2001; Dev. Cell 1(5): 717. |
| dystrophies | B. Xia et al.; 2002; Dev. Biol. 242(1): 58. |
| | T. Endo and H. Manya; 2006; 417: 137. |
| Neurological | H. Narimatsu; 2006; CNS. Neurol. Disord. Drug Targets. |
| diseases | 5(4): 441. |
| Prion-mediated | P. M. Rudd et al.; 2002; Curr. Opin. Struct. Biol. |
| diseases | 12(5): 578. |
| | C. J. Bosques and B. Imperiali; 2003; |
| | Proc. Natl. Acad. Sci. U.S.A. 100(13): 7593. |
| | M. Ermonval et al.; 2003; Biochimie 85(1-2): 33. |
| Influenza | J. Stevens et al.; 2006; J. Mol. Biol. 355(5): 1143. |
| diseases | K. F. Winklhofer et al.; 2003; Traffic. 4(5): 313. |
| (Influenza) | M. Matrosovich et al.; 2003; J. Virol. 77(15): 8418. |
| | S. J. Morris et al.; 1999; J. Gen. Virol. 80(Pt 1): 137. |

In a preferred embodiment of the method according to the invention, the tumour is selected from the group consisting of colorectal carcinoma, stomach carcinoma, mamma carcinoma, pancreatic carcinoma, melanoma, sarcoma and lymphomas, such as e.g. Hodgkin lymphoma and non-Hodgkin lympoma.

The Figures show:

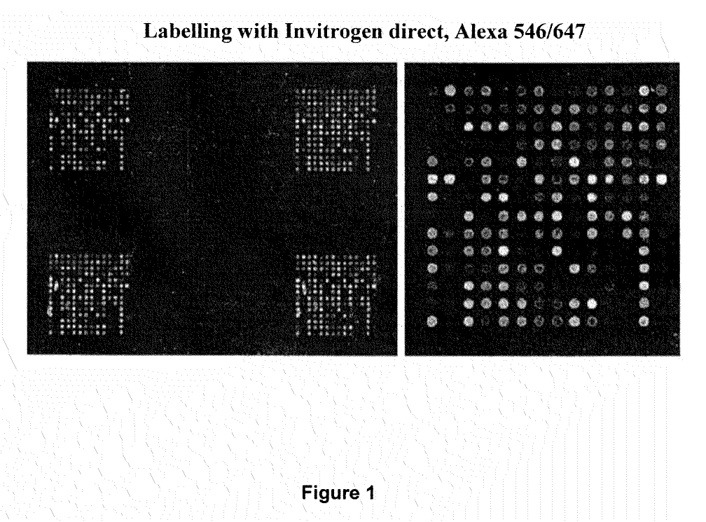

FIG. 1:

Hybridisation of the support of the invention with cDNA samples. On the left, the complete array with four fields is shown. On the right, one of the subarrays is shown magnified. cDNAs were labelled using the Invitrogen direct kit.

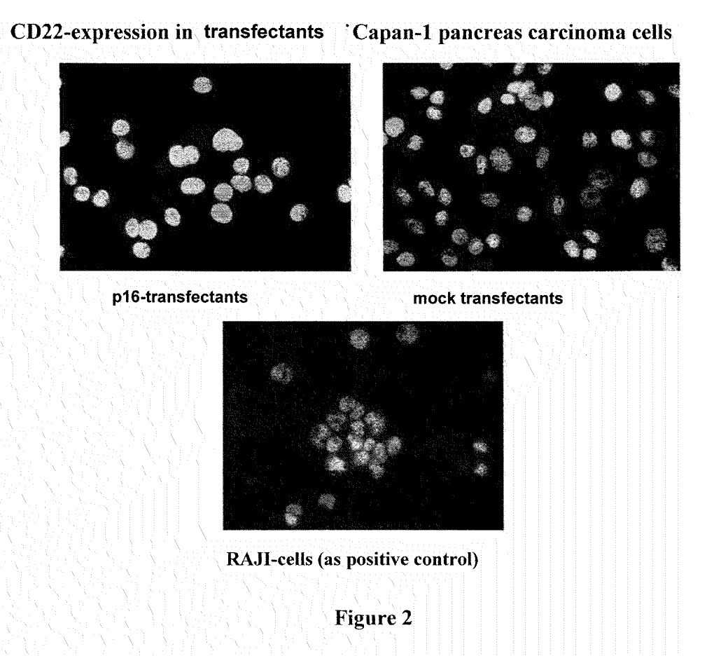

FIG. 2:

Immuno-histochemical stainings of pancreatic carcinoma cells with an antibody specific for glycoprotein CD22. p-16 transfectants correspond to p16 transfected capan cells; mock transfectants correspond to capan cells that were transfected with the same vector having antibiotic resistance, but without target sequence; RAJI cells serve as positive control. Red indicates the fluorescence of the CD22-specific antibody. Cell nuclei are marked blue (DAPI staining).

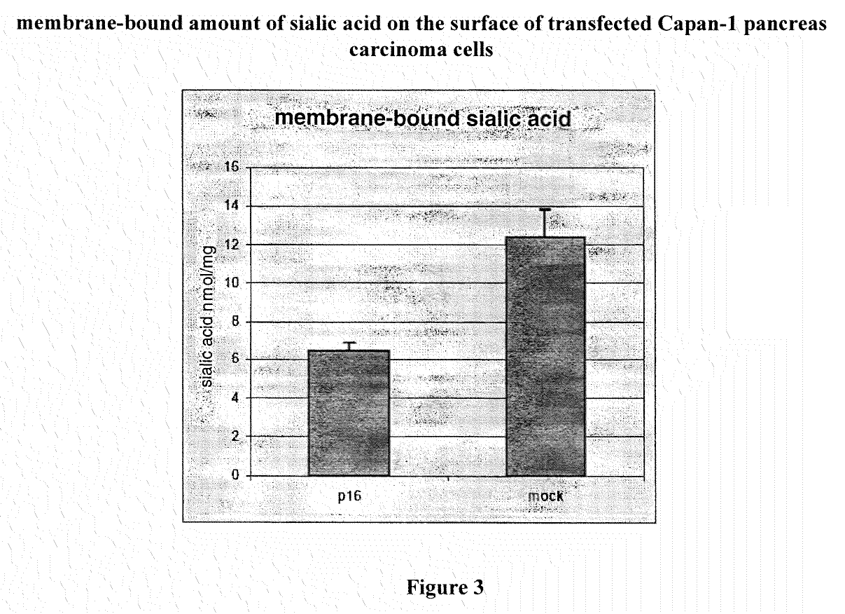

FIG. 3:

Determination of membrane-bound sialic acid on the surface of pancreatic carcinoma cells. p16 are p16-transfected capan cells; mock refers to capan cells transfected with a vector having antibiotic resistance but without target gene sequence.

The Examples illustrate the invention. The examples are not intended to limit the invention. The examples are only added to illustrate the invention and the invention is exclusively defined by the claims.

### EXAMPLE 1

Sample Preparation and Array Hybridisation

Total RNA is extracted by means of RNeasy and the quality and quantity of the RNA obtained is examined using BioAnalyzer (Agilent). Subsequently, the RNA is labelled by reverse transcription with fluorescent dyes. Different processes for labelling the cDNA samples were carried out according to the manufacturer's instructions and tested (see Table 2). A total of 7 different labelling methods using different dyes, such as Alexa 647/546 or Cy3/Cy5 as well as different reverse transcriptases were used. As a comparison, the long-established direct/indirect methods by Amersham using Cy3/Cy5 dyes and a direct method kit by Invitrogen, were tested. The latter method showed the best results with respect to signal intensity.

TABLE 2
Tests of different cDNA labelling methods

| Method | Result |
|---|---|
| Amersham direct Cy3/Cy5 | weak signals, not satisfactory |
| 3DNA Array 350 Cy3/Cy5 | signals not satisfactory |
| Amersham indirect Cy3/Cy5 | signals not sufficiently reproducible |
| 3DNA Array 900 Alexa 647/546 | not suitable |
| 3DNA Array 350 Alexa 546/647, | clear red, yellow and green signals |
| Powerscript II | |
| 3DNA Array 350 Alexa 546/647, | clear red, yellow and green signals |
| Superscript II | |
| Invitrogen direct, Alexa 546/647 | clear red, yellow and green signals |

The quality of the labelling is then examined by NanoDrop Measuring and the labelled cDNA is hybridised in the aHyb station (Miltenyi) onto the array. Fluorescence is measured by means of the AGILENT scanner and the data are evaluated using AGILENT software.

### EXAMPLE 2

Comparison of Expression Patterns of Selected Target Molecules using GlycoProfiler Array and Real Time PCR in Transfected Capan-1 Prancreatic Carcinoma Cells.

The pancreatic cell line CAPAN-1, which was transfected with the tumour suppressor gene p16 (p16) as well as a mock-transfected control cell line (CAPAN-1 transfected with the same vector having antibiotic resistance genes but no target gene sequence) were characterised by the GlycoProfiler Array.

The tumour suppressor p16 is an inhibitor of cyclin-dependant kinases (cdk4+6), Which play an important role in the control of the cell cycle by phosphorylating the product of the retinoblastoma (pRb). In the normal cell cycle, the expression of p16 is strictly controlled. The Microarray experiments show significant differences in the gene expression of glycosylation genes between the p16 cell line and the mock-transfected cell line. This confirms that glycosylation and glycosylation-dependant functions, such as lectin binding or induction of anoikis, are dramatically altered by the transfection with p16.

In addition, the hybridisation results of the Microarray were verified by quantitative real time RT-PCR (Taqman). The PCR results are used as “gold standard” to evaluate the specificity of the microarray results. For this purpose, a library of PCR primers was established for 17 of the most important target molecules of the GlycoProfiler Array. As shown in Table 3, the results of the microarray examination are in close agreement with those of the real time PCR. For example, for the enzyme UDP-N-Acetylglucosamine-2-epimerase/N-acetylmannosamine kinase (GNE), the PCR as well as the array data show very low expression of the enzyme in p16-transfected cells (Table 3). UDP-N-acetylglucosamine-2-epimerase/N-acetylmannosamine kinase is the key enzyme in the biosynthesis of sialic acids and regulates the first two steps of this metabolic pathway and, thus, plays a crucial role in its regulation. The two methods also correspond with regard to the expression of CMP-Neu/Ac synthetase (CMAS), another important “down-stream” situated enzyme of the sialic acid metabolism, which is highly increased in p16-transfected cells. As shown in the other examples (Table 3), the microarray allows satisfactory determination of the gene expression profile of the cells.

TABLE 3
Differences in the gene expression of selected
target molecules using GlycoProfiler Array (second
column) and real time PCR (first column).

| Gene | Taqman | GlycoProfiler |
|---|---|---|
| B3GNT3 | 0.09 | 0.14 |
| B3GNT5 | 4.98 | 1.93 |
| C2GNT-L | 0.33 | 0.18 |
| C2GNT-M | 0.09 | 0.10 |
| CD22 | 0.02 | 0.51 |
| CMAS | 3.00 | 2.30 |
| GNE | 0.01 | 0.04 |
| FUT6 | 0.20 | 0.91 |
| FUT8 | 0.21 | 0.31 |
| Gal-1 | 1.11 | 1.29 |
| Gal-3 | 0.64 | 0.48 |
| MGAT3 | 0.57 | 2.09 |
| MGAT5 | 0.37 | 0.72 |
| NANS | 0.57 | 0.93 |
| ST3Gal IV | 1.05 | 0.96 |
| ST6Gal I | 1.43 | 1.12 |
| ST6GalNAc II | 0.36 | 0.51 |

The expression values are shown as quotients of the expression (relative amount) of p16/mock.

### EXAMPLE 3

CD22 Expression in Transfectants of Capan-1 Pancreatic Carcinoma Cells.

Both the GlycoProfile Array as well as RT-PCR show that CD22, a sialic acid-binding lectin, is more strongly expressed in mock-transfected cells than in p16-transfected cells. As shown in FIG. 2, this reduced CD22 expression in p16-cells can also be confirmed by immuno histochemical analyses. The staining of mock-cells by a CD22-antibody is considerably more intense than the staining of p16-transfected cells (FIG. 2). Thus, in this case, it is possible to directly infer the presence of lectin protein CD22 from the CD22 expression of the mRNA.

### EXAMPLE 4

Membrane-Bound Amount of Sialic Acid on the Surface of Transfected Capan-1 Pancreatic Carcinoma Cells.

Analysis of the amount of membrane-bound sialic acid on the surface of p16-transfected and mock-transfected cells by means of a highly sensitive HPLC-based detection method (Hara et al. 1987) show that p16-transfected cells exhibit reduced sialic acid production and sialic acid density on glycoconjugates of the cell membrane (FIG. 3). The amount of sialic acid detected on the cell surface of p16-transfectants is significantly less than the amount detected on mock-transfectants (6.5 nmol sialic acid/mg protein compared to 12.4 nmol/mg).

In combination with the reduced expression of the enzyme GNE—the key enzyme of sialic acid synthesis—in p16-transfected cells as shown in Example 2, these results demonstrate that it is possible to infer, at least to a certain degree from the mRNA expression of GNE, the density of sialic acid on the cell surface.

### EXAMPLE 5

Glycoprofiling of Cell Lines Under Different Culture Conditions.

Glycoprofiling can be used to control temporal changes in the expression pattern of the glycosylation apparatus of cell lines subjected e.g. to modified culture conditions. The effect of the serum content as well as of temperature and gases is of particular relevance for the culture of production cell lines. It is therefore of interest to characterise the expression pattern of the glycosylation apparatus of cell lines under serum depletion or upon culture in serum-free media by means of the microarray technique.

Extraction of total RNA and labelling of cDNA, hybridisation with the array and data evaluation are carried out as described in Example 2.

### EXAMPLE 6

Glycoprofiling of Glyco-Engineered Production Cell Lines.

It is possible to glyco-engineer cell lines by transfecting glycosyltransferases or by silencing them using siRNA techniques. To analyse how such manipulations are reflected at the level of glycoprofiling and whether other elements which are different from those elements of the glycosylation machinery that have been changed potentially react to these manipulations, the GlycoProfiler Array may be used. It allows determining qualitative and quantitative changes of the different glycosyltransferases expressed in a cell line after a specific glycoengineering.

For this purpose, selected glycosyltransferases, such as sialyltransferase ST6Gal-1, are over-expressed in cell lines or are reduced or eliminated by siRNA and the expression pattern of the glycosylation apparatus of the cells is analysed. Extraction of total RNA as well as labelling of cDNA, hybridisation with the array and data evaluation are carried out as described in Example 2.

### EXAMPLE 7

Glycoprofiling of Human Tumour Tissues.

It is very difficult to quantitatively measure individual glycan structures on cells or in tissue due to their complexity and their presence in only small amounts. The above-mentioned examples, however, show that the expression profile of glycosyltransferases present in a cell can provide information about the glycan structures formed and, thus, may be of diagnostic interest.

20 samples of colorectal carcinomas, gastric carcinomas and mamma carcinomas and of the related normal tissues, respectively, are analysed and their profiles compared with the results of real time PCR.

To this aim, tissues are cut using a cryostat and examined by an experimental pathologist. The selection and examination of the material to be analysed are particularly important for the subsequent analyses. Only biopsies which contain more than 60% carcinoma tissue, no lymph follicles, little connective tissue and only small amounts of fatty tissue and which show no symptoms of necrosis are further processed. The extraction of total RNA, labelling of cDNA, hybridisation with the array and data evaluation are carried out as described in Example 2.

In this way it is possible to gather expression profiles of carcinomas with different prognosis and to correlate the expression data with categories such as metastasis of the carcinoma and the survival time of the patients.

### Further Literature

Auburn R P, Kreil D P, Meadows L A, Fischer B, Matilla S S, Russell S. Robotic spotting of cDNA and oligonucleotide microarrays. Trends Biotechnol. July 2005; 23(7):374-9.

Ausubel, “Current Protocols in Molecular Biology”, Green Publishing Associates and Wiley Interscience, N.Y., 1989

Baum L G. Developing a taste for sweets. Immunity. January 2002; 16(1):5-8.

Castoldi M, Schmidt S, Benes V, Noerholm M, Kulozik A E, Hentze M W, Muckenthaler M U A sensitive array for microRNA expression profiling (miChip) based on locked nucleic acids (LNA). RNA. May 2006; 12(5):913-20.

Dall'Olio F, Malagolini N, di Stefano G, Minni F, Marrano D, Serfini-Cessi F. Increased CMP-NeuAc:Gal beta 1,4GlcNAc-R alpha 2,6 sialyltransferase activity in human colorectal cancer tissues. Int J Cancer. Sep. 15, 1989; 44(3):434-9.

Ding C, and Cantor C. R., Quantitative Analysis of Nucleic Acids—the Last Few Years of Progress. Journal of Biochemistry and Molecular Biology. 2004 37, 1-10.

Gao X, LeProust E, Zhang H, Srivannavit O, Gulari E, Yu P, Nishiguchi C, Xiang Q, Zhou X. A flexible light-directed DNA chip synthesis gated by deprotection using solution photogenerated acids. Nucleic Acids Res. Nov. 15, 2001; 29(22):4744-50.

Hara S, Takemori Y, Yamaguchi M, Nakamura M, Ohkura Y. Fluorometric high-performance liquid chromatography of N-acetyl- and N-glycolylneuraminic acids and its application to their microdetermination in human and animal sera, glycoproteins, and glycolipids. Anal Biochem. July 1987; 164(1):138-45.

Harlow et al., Antibodies: A Laboratory Manual, Cold Spring Harbor Laboratory Press, 1988

Harris and Winssinger, PNA encoding (PNA=peptide nucleic acid): from solution-based libraries to organized microarrays. Chemistry. Nov. 18, 2005; 11(23):6792-801.

Higgins and Hames (Eds.) “Nucleic acid hybridization, a practical approach” IRL Press Oxford, Washington D.C., 1985

Kamme F, Salunga R, Yu J, Tran D T, Zhu J, Luo L, Bittner A, Guo H Q, Miller N, Wan J, Erlander M. Single-cell microarray analysis in hippocampus CA1: demonstration and validation of cellular heterogeneity. J Neurosci. May 1, 2003; 23(9):3607-15.

Kemmner W, Kruck D, Schlag P., Different sialyltransferase activities in human colorectal carcinoma cells from surgical specimens detected by specific glycoprotein and glycolipid acceptors. Clin Exp Metastasis. May 1994; 12(3):245-54.

Lausted C, Dahl T, Warren C, King K, Smith K, Johnson M, Saleem R, Aitchison J, Hood L, Lasky S R. POSaM: a fast, flexible, open-source, inkjet oligonucleotide synthesizer and microarrayer. Genome Biol. 2004; 5(8):R58. Epub Jul. 27, 2004.

Lefebvre J C, Giordanengo V, Doglio A, Cagnon L, Breittmayer J P, Peyron J F, Lesimple J. Altered sialylation of CD45 in HIV-1-infected T lymphocytes. Virology. March 1994; 199(2):265-74.

Manduchi E, Scearce L M, Brestelli J E, Grant G R, Kaestner K H, Stoeckert C J Jr. Comparison of different labeling methods for two-channel high-density microarray experiments. Physiol Genomics. Sep. 3, 2002; 10(3):169-79.

Osborne, S E et al.: Aptamers as therapeutic and diagnostic reagents: problems and prospects. Curr Opin Chem Biol. June 1997; 1(1):5-9

Sambrook, Russell “Molecular Cloning, A Laboratory Manual”, Cold Spring Harbor Laboratory, N.Y., 2001

Schneider F, Kemmner W, Haensch W, Franke G, Gretschel S, Karsten U, Schlag P M. Overexpression of sialyltransferase CMP-sialic acid:Galbeta1,3GalNAc-R alpha6-Sialyltransferase is related to poor patient survival in human colorectal carcinomas. Cancer Res. Jun. 1, 2001; 61(11):4605-11.

Sperandio, M.: Selectins and glycosyltransferases in leukocyte rolling in vivo. FEBS J. October 2006; 273(19):4377-89

Stevens J, Blixt O, Glaser L, Taubenberger J K, Palese P, Paulson J C, Wilson I A. Glycan microarray analysis of the hemagglutinins from modern and pandemic influenza viruses reveals different receptor specificities. J Mol Biol. Feb. 3, 2006; 355(5): 1143-55

1. A support onto which a set of probes is deposited wherein the set comprises:
(a) probes capable of specifically hybridising with nucleic acids encoding fucosyltransferases;
(b) probes capable of specifically hybridising with nucleic acids encoding galactosyltransferases;
(c) probes capable of specifically hybridising with nucleic acids encoding N-acetylglucosaminyltransferases;
(d) probes capable of specifically hybridising with nucleic acids encoding N-acetylgalactosaminyltransferases;
(e) probes capable of specifically hybridising with nucleic acids encoding sialyltransferases;
(f) probes capable of specifically hybridising with nucleic acids encoding sugar sulfotransferases;
(g) probes capable of specifically hybridising with nucleic acids encoding lectins;
(h) probes capable of specifically hybridising with nucleic acids encoding selectins;
(i) probes capable of specifically hybridising with nucleic acids encoding fucosidases;
(j) probes capable of specifically hybridising with nucleic acids encoding neuraminidases (sialidases);
(k) probes capable of specifically hybridising with nucleic acids encoding nucleotide sugar epimerases;
(l) probes capable of specifically hybridising with nucleic acids encoding sugar kinases;
(m) probes capable of specifically hybridising with nucleic acids encoding sugar epimerases; and
(n) probes capable of specifically hybridising with nucleic acids encoding sugar transporters; and
(o) probes capable of specifically hybridising with nucleic acids encoding enzymes of the fucose or sialic acid metabolism.

2. A support onto which a set of probes is deposited wherein the set comprises:
(a) probes capable of specifically hybridising with nucleic acids encoding fucosyltransferases;
(b) probes capable of specifically hybridising with nucleic acids encoding galactosyltransferases;
(c) probes capable of specifically hybridising with nucleic acids encoding N-acetylglucosaminyltransferases;
(d) probes capable of specifically hybridising with nucleic acids encoding N-acetylgalactosaminyltransferases;
(e) probes capable of specifically hybridising with nucleic acids encoding sialyltransferases;
(f) probes capable of specifically hybridising with nucleic acids encoding sugar sulfotransferases;
(g) probes capable of specifically hybridising with nucleic acids encoding lectins;
(h) probes capable of specifically hybridising with nucleic acids encoding selectins;
(i) probes capable of specifically hybridising with nucleic acids encoding fucosidases;
(j) probes capable of specifically hybridising with nucleic acids encoding neuraminidases (sialidases);
(k) probes capable of specifically hybridising with nucleic acids encoding nucleotide sugar epimerases;
(l) probes capable of specifically hybridising with nucleic acids encoding sugar kinases;
(m) probes capable of specifically hybridising with nucleic acids encoding sugar epimerases;
(n) probes capable of specifically hybridising with nucleic acids encoding sugar transporters; and /or
(o) probes capable of specifically hybridising with nucleic acids encoding enzymes of the fucose or sialic acid metabolism;
wherein at least one probe selected from (k), (l) or (m) is contained in the set of probes.

3. The support according to claim 1 or 2 which is a solid support.

4. The support according to claim 3, wherein the support is glass.

5. The support according to claim 1, wherein the probes are oligonucleotide probes.

6. The support according to claim 1, wherein the probes have a length of approximately 70 bases.

7. The support according to claim 1, wherein the fucosyltransferases, galactosyltransferases, N-acetylglucosaminyltransferases, N actylgalactosaminyltransferases, sialyltransferases, sugar sulfotransferases, lectins, selectins, fucosidases, neuraminidases, sialidases, nucleotide sugar epimerases, sugar kinases, sugar epimerases, sugar transporters and/or enzymes of the fucose or sialic acid metabolism are selected from Table 1.

8. The support according to claim 1, wherein each of the proteins of Table 1 is represented by at least one probe on the support.

9. A kit, comprising the set of probes as defined in any one of claims 1 or 2.

10. (canceled)

11. A method for the quantitative determination of the expression of nucleic acids encoding fucosyltransferases, galactosyltransferases, N acetylglucosaminyltransferases, N-actylgalactosaminyltransferases, sialyltransferases, sugar sulfotransferases, lectins, selectins, fucosidases, neuraminidases (sialidases), nucleotide sugar epimerases, sugar kinases, sugar epimerases, sugar transporters and/or enzymes of the fucose or sialic acid metabolism comprising the steps
(a) contacting the support of claim 1 with a preparation of labelled nucleic acids obtained by reverse transcription of mRNAs present in a sample obtained from a cell, a tissue or an organism; and
(b) quantifying the amount of label bound to the probes on the support.

12. The method according to claim 11, further comprising the step of
(c) determining the expression of the fucosyltransferases, galactosyltransferases, N-acetylglucosaminyl transferases, N acetylgalactosaminyl transferases, sialyltransferases, sugar sulfotransferases, lectins, selectins, fucosidases, neuraminidases, sialidases, nucleotide sugar epimerases, sugar kinases, sugar epimerases, sugar transporters and/or enzymes of the fucose or sialic acid metabolism, wherein the determination of the expression in step (c) comprises
(I) determining the amount of mRNA by means of PCR, Ribonuclease Protection Assay or SAGE (“Serial Analysis of Gene Expression”); and/or
(II) determining the amount of protein.

13. The method according to claim 12, wherein the determination in step (c) is carried out using antibodies which are specific for the fucosyltransferases, galactosyltransferases, N-acetylglucosaminyltransferases, N acetylgalactosaminyltransferases sialyltransferases, sugar sulfotransferases, lectins, selectins, fucosidases, neuraminidases, sialidases, nucleotide sugar epimerases, sugar kinases, sugar epimerases, sugar transporters and/or enzymes of the fucose or sialic acid metabolism.

14. The method of claim 11, wherein the expression indicates
(a) the status of glycosylation;
(b) the disease state;
(c) malignancy; and/or
(d) the potential of formation of metastases
of the cell, the tissue or the organism.

15. A diagnostic composition, comprising the set of probes as defined in any one of claims 1 or 2.

16. Use of the set of probes as defined in claims 1 or 2 for the preparation of one or more diagnostic compositions or of a diagnostic apparatus for the diagnosis of tumours, inflammatory and/or neurological diseases.

17. The use according to claim 16, wherein the tumour is selected from the group consisting of colorectal carcinoma, gastric carcinoma, mamma carcinoma, pancreatic carcinoma, melanoma, sarcoma and lymphoma, such as Hodgkin's lymphoma and Non-Hodgkin's lymphoma.
